(19) United States
(12) Patent Application Publication
(10) Pub. No.: US 2013/0183843 A1
(43) Pub. Date: Jul. 18, 2013

(54) UNIVERSAL PLUG ADAPTOR

(71) Applicant: CHIU-SAN LEE, New Taipei City (TW)

(72) Inventor: CHIU-SAN LEE, New Taipei City (TW)

(21) Appl. No.: 13/351,229

(22) Filed: Jan. 17, 2012

(51) Int. Cl. H01R 27/02

(52) U.S. Cl. 439/222

(57) ABSTRACT

The universal plug adaptor contains a terminal set for contacting plug pins housed between a face plate and a casing. The face plate contains a number of sets of plug holes. A first hole set contains a first live hole, a first neutral hole, and a first ground hole conforming to the South Africa specification. A second hole set contains three separate openings, each containing a number of plug holes for ground pins of various specifications. A third hole set contains two plug holes conforming to global 250V specification with two flat pins or two round pins. A fourth hole set contains two plug holes conforming to America 125V specification's two flat pints or two round pins. And a fifth hole set contains two plug holes conforming to America specification with two flat pins. The third and fourth hole sets jointly provide two plugs' simultaneous plugging.

### TECHNICAL FIELD OF THE INVENTION

The present invention is generally related to universal plug adaptors, and more particular to a universal plug adaptor allowing simultaneous plugging of two plugs.

### DESCRIPTION OF THE PRIOR ART

There are various types of electrical plugs and sockets that are different by country in rating, shape, and size.

Due to the rapid electronic technology, most products are designed with energy saving in mind. The conventional wall sockets do not fit this requirement. Additionally, the loose coupling between the plug and socket often causes disconnection or short circuit. When an extension cord is applied, the longer the cord, the more voltage drops and the temperature rises. There is indeed some safety problem to be considered.

Furthermore, the compatibility and robustness of the coupling between the plug pin and the socket terminal has to be designed with the required safety standard. The material cost is also a major concern considering the continuously rising cost. For example, for the standard socket of China and Australia, they need to receive three kinds of plugs and the socket face plate therefore requires a sizable area, thereby a higher cost. Each socket usually can only receive one type of plug and this limitation restricts the flexibility significantly. In the nearby areas, Hong Kong uses British plugs, similar to Singapore and Malaysia. In contrast, Taiwan uses America plugs. A flexible socket of plug adaptor has to take all these into consideration.

Again, for Taiwan's plug, due to its smaller form factor, its usability and safety have to be reconsidered, in addition to energy saving, product quality, and environment friendliness.

### SUMMARY OF THE INVENTION

To obviate the foregoing shortcomings, a universal plug adaptor is provided herein. The major objectives of the present invention are as follows.

Firstly, for industries producing products for worldwide market, the present invention provides the industries a convenient tool for testing compatibility with specifications of various countries.

Secondly, with the present invention, the wall sockets can be more versatile, support more plugs, provide more safety control for reduced possibility of hazard.

Thirdly, the present invention conforms to the China's standard plug and supports two plugs' simultaneous plugging, making the present invention more convenient and economical.

Fourthly, the present invention supports both America and Taiwan plugs and supports two plugs' simultaneous plugging with more safety control.

Fifth, the present invention is universally applicable to the plugs of various countries. The present invention can be further stacked with additional face plates to achieve even greater applicability.

To achieve the above objectives, the universal plug adaptor contains a face plate having a number of plug holes, and a casing joined to the face plate with a terminal set inside for contacting plug pins. Between the face plate and the casing, a safety-door device conforming to the South Africa specification is configured. The face plate contains a number of sets of plug holes aligned and distributed symmetrically along a middle line of the face plate. A first hole set contains a first live hole, a first neutral hole, and a first ground hole conforming to the South Africa specification. A second hole set contains three separate openings. The first opening contains a second ground hole conforming to the Britain specification, a third ground hole adjacent to the second ground hole conforming to the India specification, a fourth ground hole adjacent to the third ground hole conforming to the China and Australia 10A and 16A specifications, a fifth ground hole adjacent to the fourth ground hole conforming to the Denmark specifications, a sixth ground hole adjacent to the fifth ground hole conforming to the Philippine 10A specification of America 250V, a seventh ground hole coinciding with the sixth ground hole conforming to the America 15A specification, an eighth ground hole coinciding with the sixth and seventh ground holes conforming to the America 20A specification, a ninth ground hole adjacent to the sixth, seventh, and eighth ground holes and conforming to the Middle East specification, and a tenth ground hole adjacent to the ninth ground hole and conforming to the Israel specification. The second opening contains an eleventh ground hole conforming to the Brazil specification and a twelfth ground hole adjacent to the eleventh ground hole and conforming to the Italy specification. The third opening contains a thirteenth ground hole conforming to Swiss specification, and the fourteenth ground hole and the fifteenth ground hole, together with a fifth hole set, conforming to two types of America 125V specifications. A third hole set contains two symmetric plug holes conforming to global 250V specification with two flat pins or two round pins. A fourth hole set contains two symmetric plug holes conforming to America 125V specification with two flat pints or two round pins. And the fifth hole set contains two plug holes conforming to the America 125V specification with two flat pins. Especially, the third and fourth hole sets, together with the second hole set, jointly provide two plugs' simultaneous plugging.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a preferred embodiment of the face plate of the present invention.

FIG. 2 is a perspective diagram showing the various components of a universal plug adaptor according to the present invention.

FIG. 3 is a schematic diagram showing a Britain plug received by a first embodiment of the present invention.

FIG. 4 is a schematic diagram showing an India plug received by a first embodiment of the present invention.

FIG. 5 is a schematic diagram showing one of a China and Australia 10A and 16A plugs received by a first embodiment of the present invention.

FIG. 6 is a schematic diagram showing one of a China and Australia 10A and 16A plugs received by a first embodiment of the present invention.

FIG. 7 is a schematic diagram showing a Denmark plug received by a first embodiment of the present invention.

FIG. 8 is a schematic diagram showing a Philippine 10A plug of America 250V received by a first embodiment of the present invention.

FIG. 9 is a schematic diagram showing an America 15A plug received by a first embodiment of the present invention.

FIG. 10 is a schematic diagram showing America 20A plug received by a first embodiment of the present invention.

FIG. 11 is a schematic diagram showing a Middle East plug received by a first embodiment of the present invention.

FIG. 12 is a schematic diagram showing an Israel plug received by a first embodiment of the present invention.

FIG. 13 is a schematic diagram showing a Brazil plug received by a first embodiment of the present invention.

FIG. 13 is a schematic diagram showing a Brazil plug received by a first embodiment of the present invention.

FIG. 14 is a schematic diagram showing a Brazil plug received by an Italy embodiment of the present invention.

FIG. 15 is a schematic diagram showing a Swiss plug received by a first embodiment of the present invention.

FIG. 16 is a schematic diagram showing a type of America 125V plug received by a first embodiment of the present invention.

FIG. 17 is a schematic diagram showing another type of America 125V plug received by a first embodiment of the present invention.

FIG. 18 is a schematic diagram showing a face plate according to a first embodiment of the present invention.

FIG. 19 is a schematic diagram showing a South Africa plug received by a preferred embodiment of the present invention.

FIG. 20 is a schematic diagram showing the safety-door device of a preferred embodiment of the present invention.

FIG. 21 is a schematic diagram showing the safety-door device when a South Africa plug is received by a preferred embodiment of the present invention.

FIG. 22 is a schematic diagram showing a face plate according to a third embodiment of the present invention.

FIG. 23 is a schematic diagram showing a face plate according to a fourth embodiment of the present invention.

FIG. 24 is a schematic diagram showing a face plate according to a fifth embodiment of the present invention.

FIG. 25 is a schematic diagram showing a face plate according to a sixth embodiment of the present invention.

FIG. 26 is a schematic diagram showing a face plate according to a seventh embodiment of the present invention.

FIG. 26A is a schematic diagram showing a variation of the face plate according to a seventh embodiment of the present invention.

FIG. 26B is a schematic diagram showing another variation of the face plate according to a seventh embodiment of the present invention.

FIG. 27 is a schematic diagram showing a face plate according to an eighth embodiment of the present invention.

FIG. 28 is a schematic diagram showing a variation of the face plate according to an eighth embodiment of the present invention.

FIG. 29 is a schematic diagram showing a variation of the face plate according to an eighth embodiment of the present invention.

FIG. 30 is a schematic diagram showing a variation of the face plate according to an eighth embodiment of the present invention.

FIG. 31 is a schematic diagram showing a variation of the face plate according to an eighth embodiment of the present invention.

FIG. 32 is a schematic diagram showing a variation of the face plate according to an eighth embodiment of the present invention.

FIG. 33 is a schematic diagram showing a variation of the face plate according to an eighth embodiment of the present invention.

FIG. 34 is a schematic diagram showing a face plate according to a ninth embodiment of the present invention.

FIG. 35 is a schematic diagram showing a variation of the face plate according to a ninth embodiment of the present invention.

FIG. 36 is a schematic diagram showing a variation of the face plate according to a ninth embodiment of the present invention.

FIG. 37 is a schematic diagram showing a variation of the face plate according to a ninth embodiment of the present invention.

FIG. 38 is a schematic diagram showing a variation of the face plate according to a ninth embodiment of the present invention.

FIG. 39 is a schematic diagram showing a variation of the face plate according to a tenth embodiment of the present invention.

FIG. 40 is a schematic diagram showing a variation of the face plate according to a tenth embodiment of the present invention.

FIG. 41 is a schematic diagram showing a variation of the face plate according to a tenth embodiment of the present invention.

FIG. 42 is a schematic diagram showing a variation of the face plate according to a tenth embodiment of the present invention.

FIG. 43 is a schematic diagram showing a variation of the face plate according to a tenth embodiment of the present invention.

FIG. 44 is a schematic diagram showing a variation of the face plate according to a tenth embodiment of the present invention.

FIG. 45 is a schematic diagram showing a face plate according to an eleventh embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

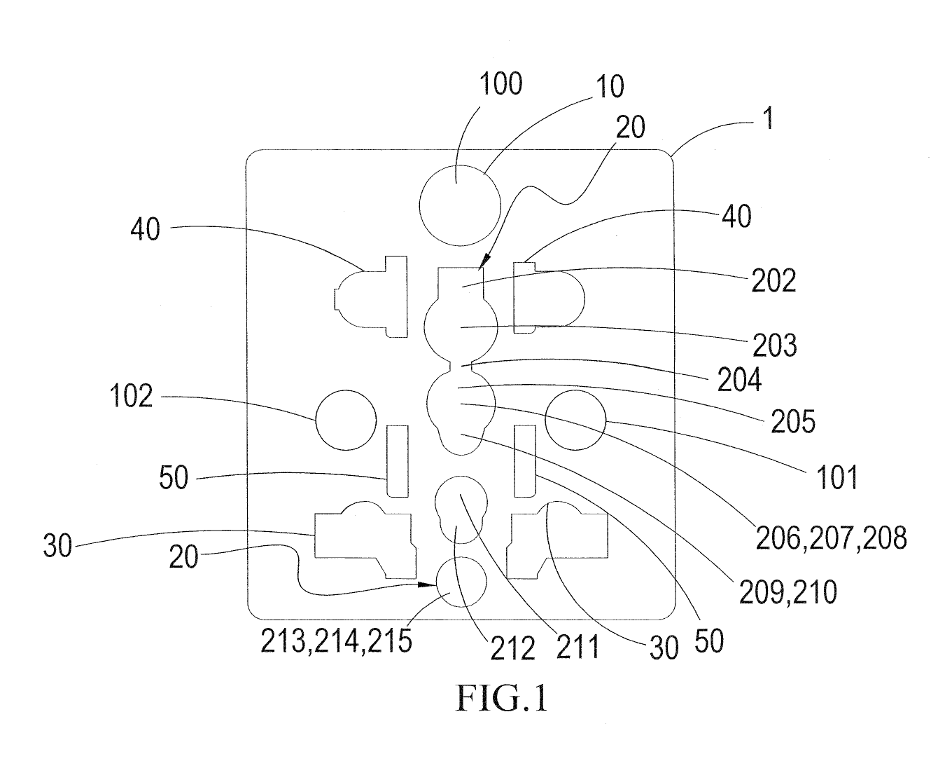

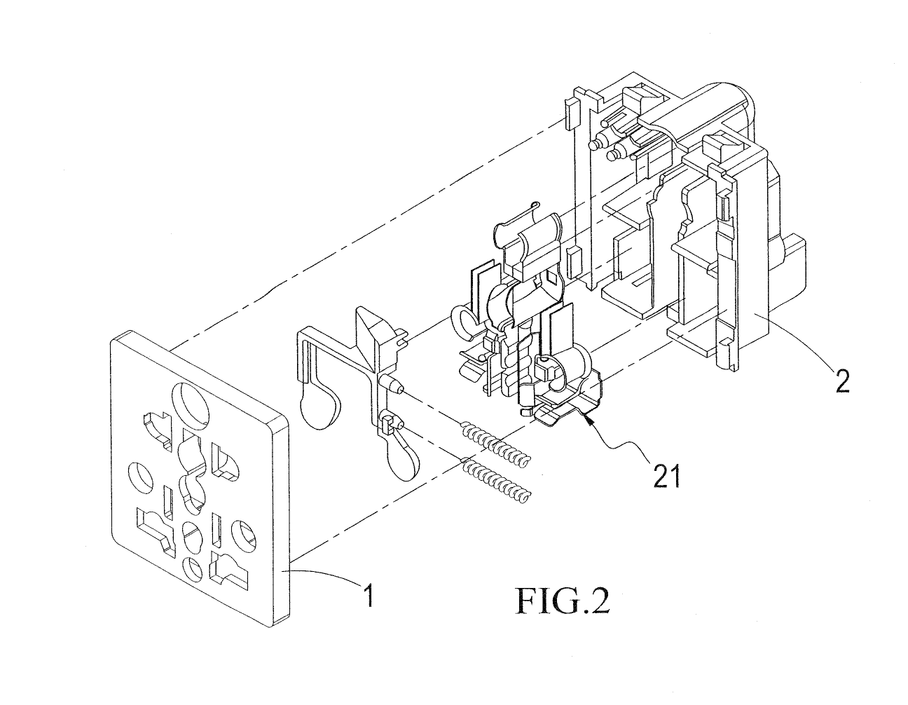

As shown in FIGS. 1 and 2, a universal plug adaptor according to the present invention contains a face plate 1 having a number of plug holes, and a casing 2 joined to the face plate 1 with a terminal set 21 inside for contacting plug pins. Between the face plate 1 and the casing 2, a safety-door device conforming to the South Africa specification is configured. The face plate 1 contains a number of sets of plug holes aligned and distributed symmetrically along a middle line of the face plate 1. A first hole set 10 contains a first live hole 101 (for live pin), a first neutral hole 102 (for neutral pin), and a first ground hole 100 conforming to the South Africa specification. A second hole set 20 contains three separate openings sequentially arranged along the middle line, each being a combination of ground holes connected sequentially together: The first opening contains a second ground hole 202 conforming to the Britain specification, a third ground hole 203 adjacent to the second ground hole 202 conforming to the India specification, a fourth ground hole 204 adjacent to the third ground hole 203 conforming to the China and Australia 10A and 16A specifications, a fifth ground hole 205 adjacent to the fourth ground hole 204 conforming to the Denmark specifications, a sixth ground hole 206 adjacent to the fifth ground hole 205 conforming to the Philippine 10A specification of America 250V, a seventh ground hole 207 coinciding with the sixth ground hole 206 conforming to the America 15A specification, an eighth ground hole coinciding with the sixth and seventh ground holes 207 and 208 conforming to the America 20A specification, a ninth ground hole 209 adjacent to the sixth, seventh, and eighth ground holes 206, 207, and 208 and conforming to the Middle East specification, and a tenth ground hole 210 adjacent to the ninth ground hole 209 and conforming to the Israel specification. The second opening contains an eleventh ground hole 211 conforming to the Brazil specification and a twelfth ground hole 212 adjacent to the eleventh ground hole 211 and conforming to the Italy specification. The third opening contains a thirteenth ground hole 213 conforming to Swiss specification, and the fourteenth ground hole 214 and the fifteenth ground hole 215, together with a fifth hole set 50, conforming to two types of America 125V specifications. A third hole set 30 contains two symmetric plug holes conforming to global 250V specification's two flat pins or two round pins. A fourth hole set 40 contains two symmetric plug holes conforming to America 125V specification's two flat pints or two round pins. And the fifth hole set 50 contains two plug holes conforming to the America 125V specification with two flat pins. Especially, the third and fourth hole sets 30 and 40, together with the second hole set 20, jointly provide two plugs' simultaneous plugging.

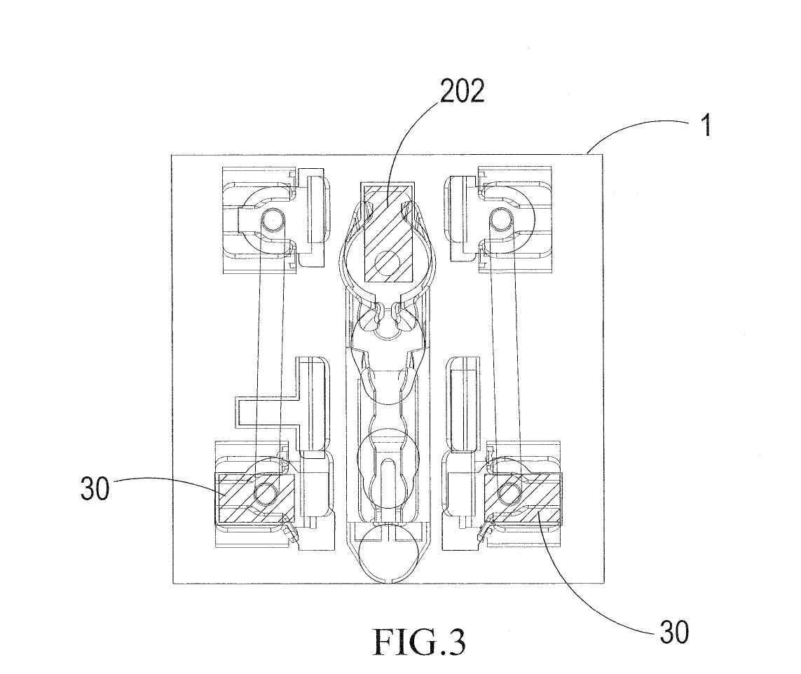

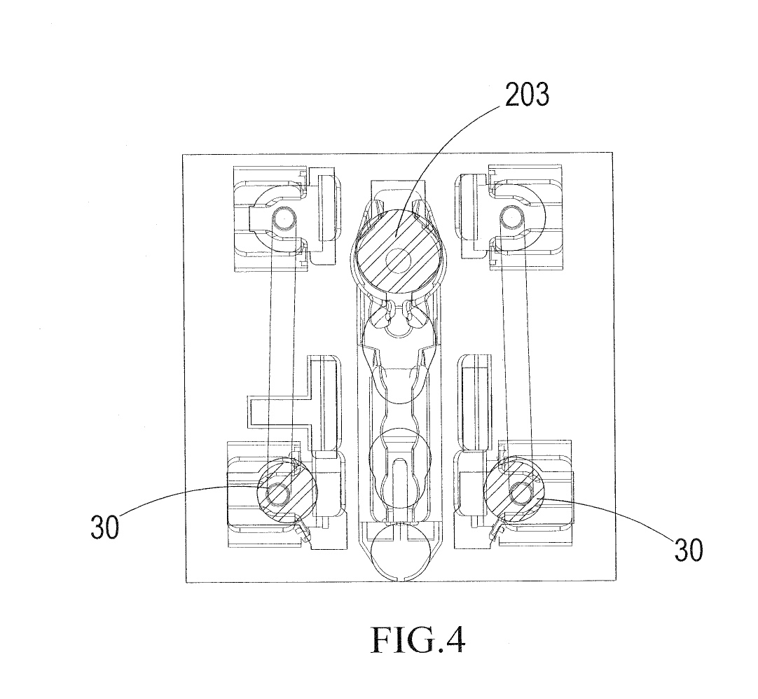

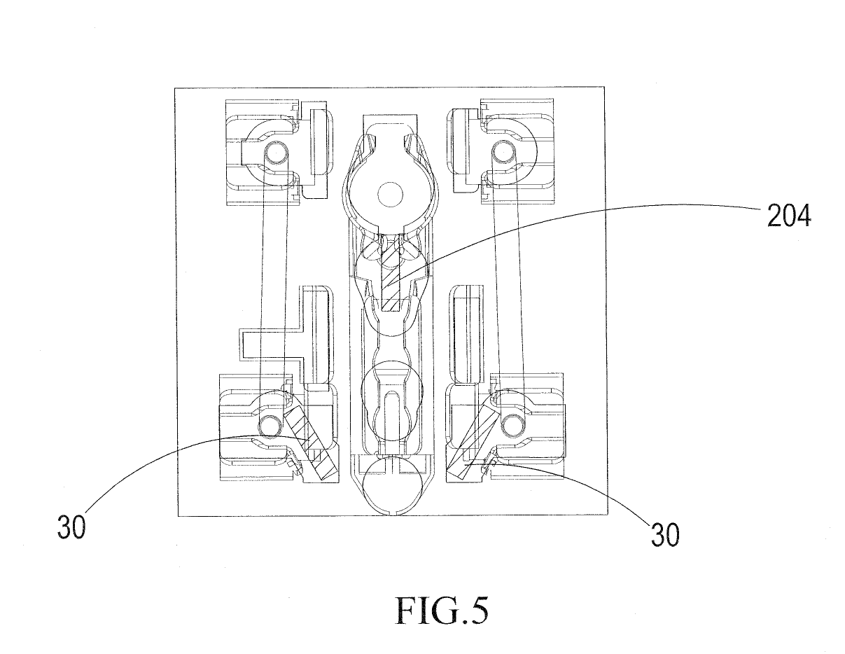

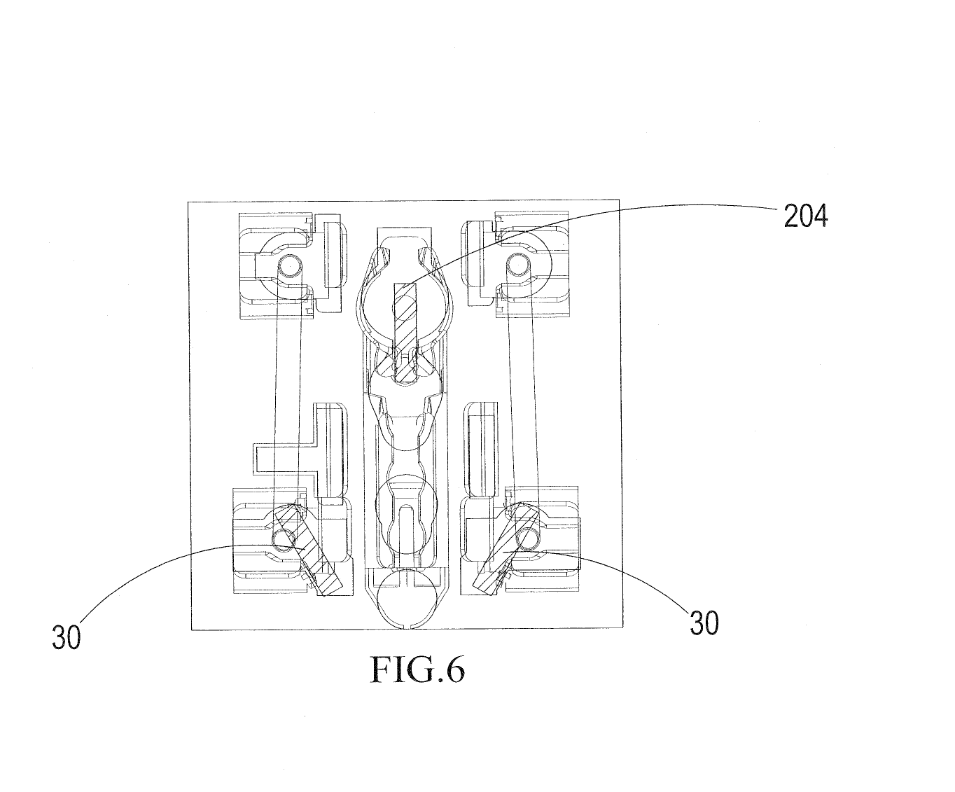

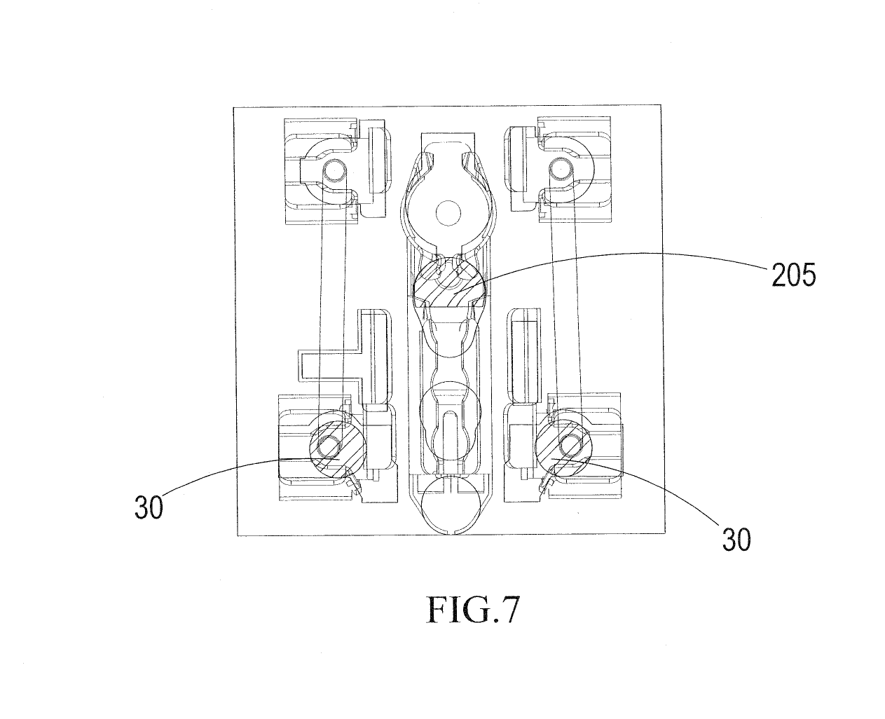

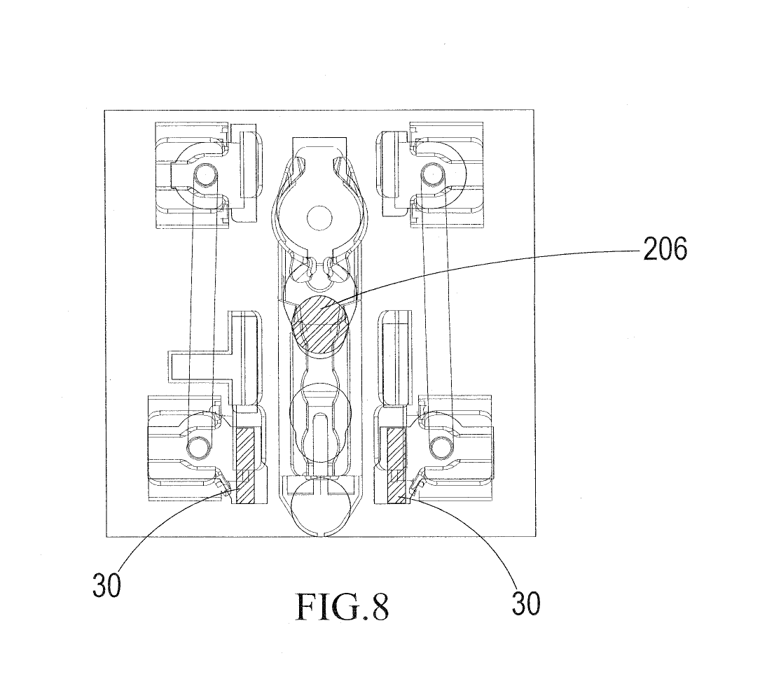

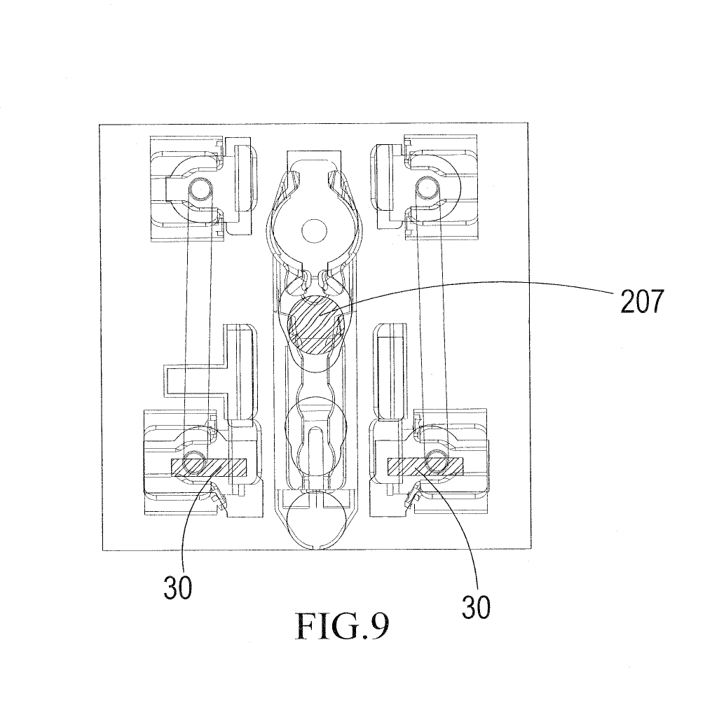

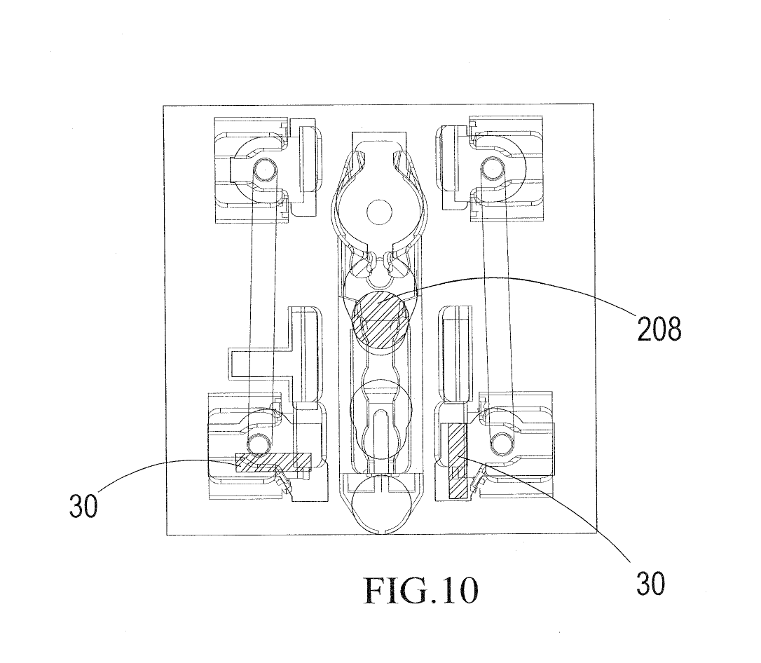

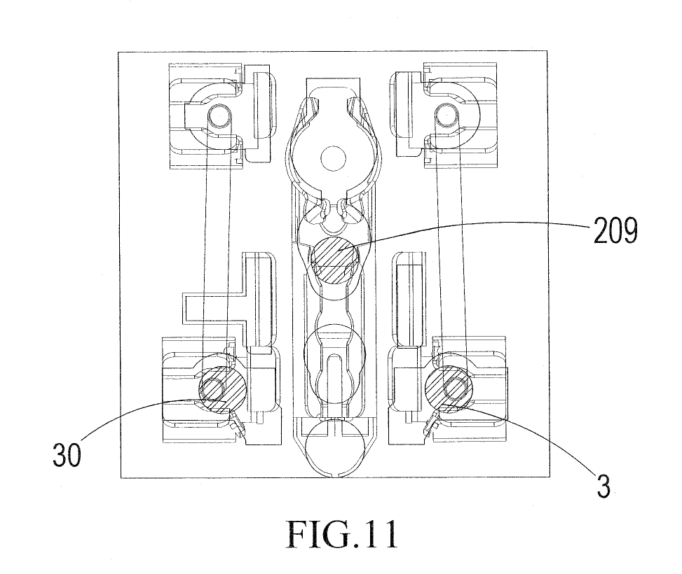

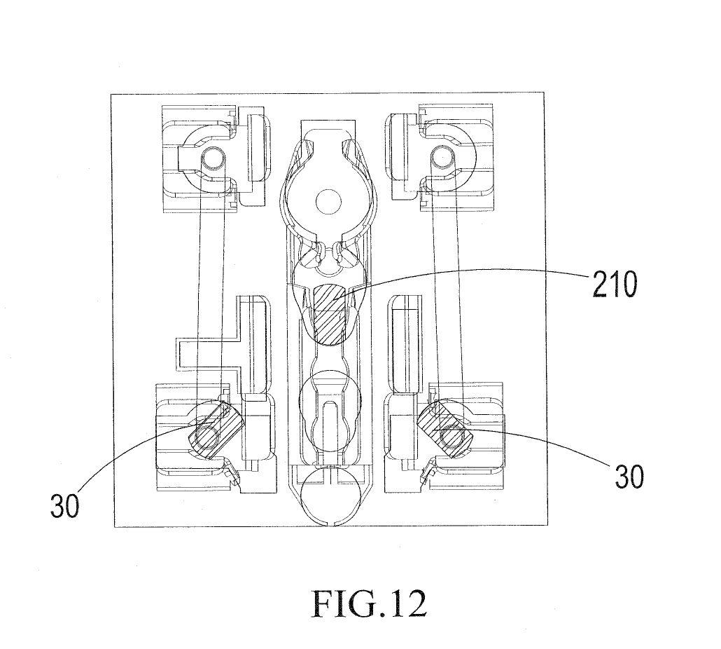

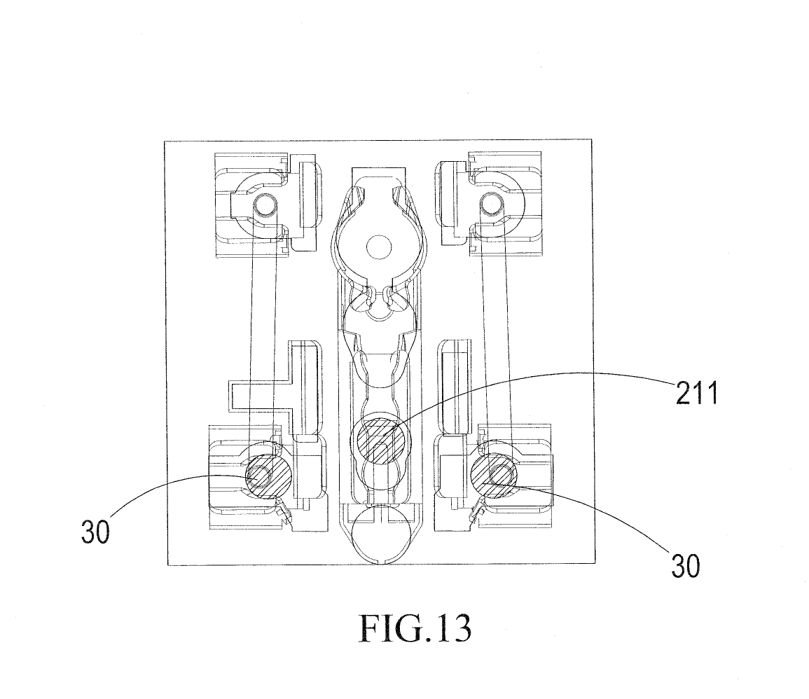

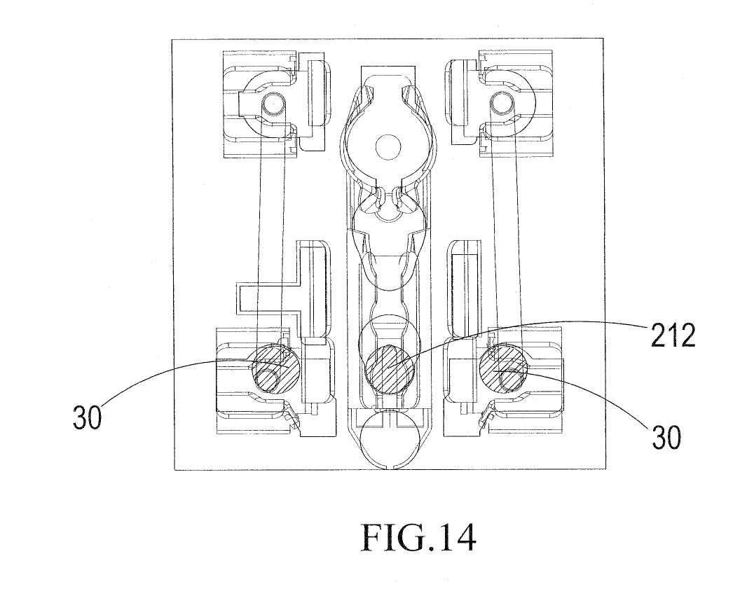

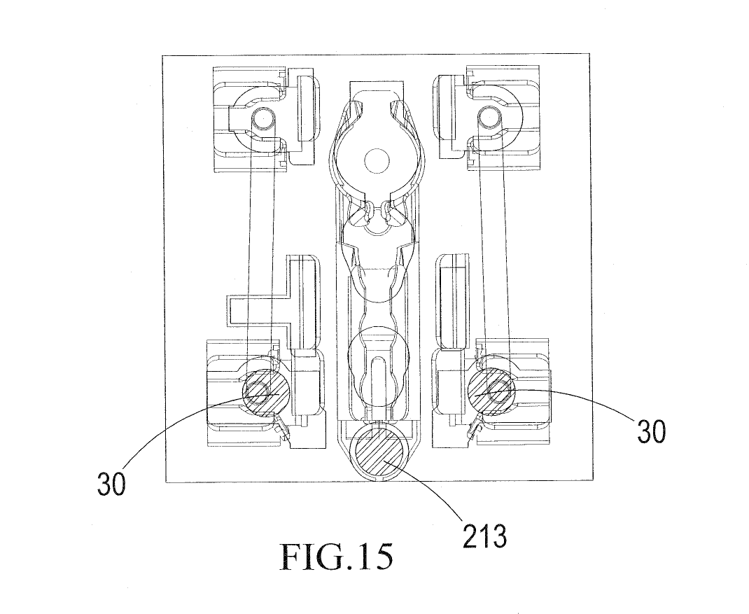

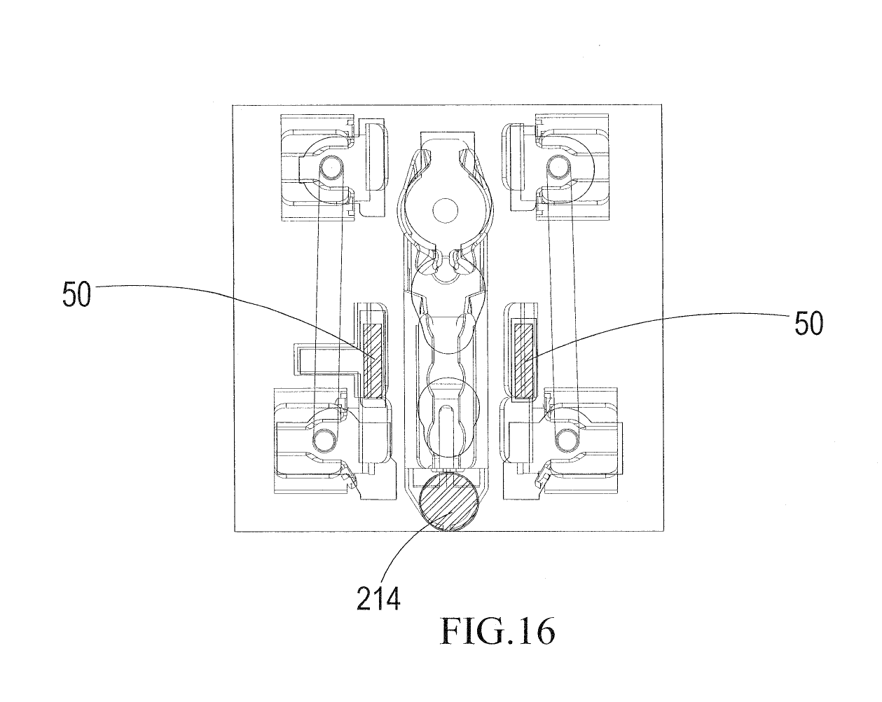

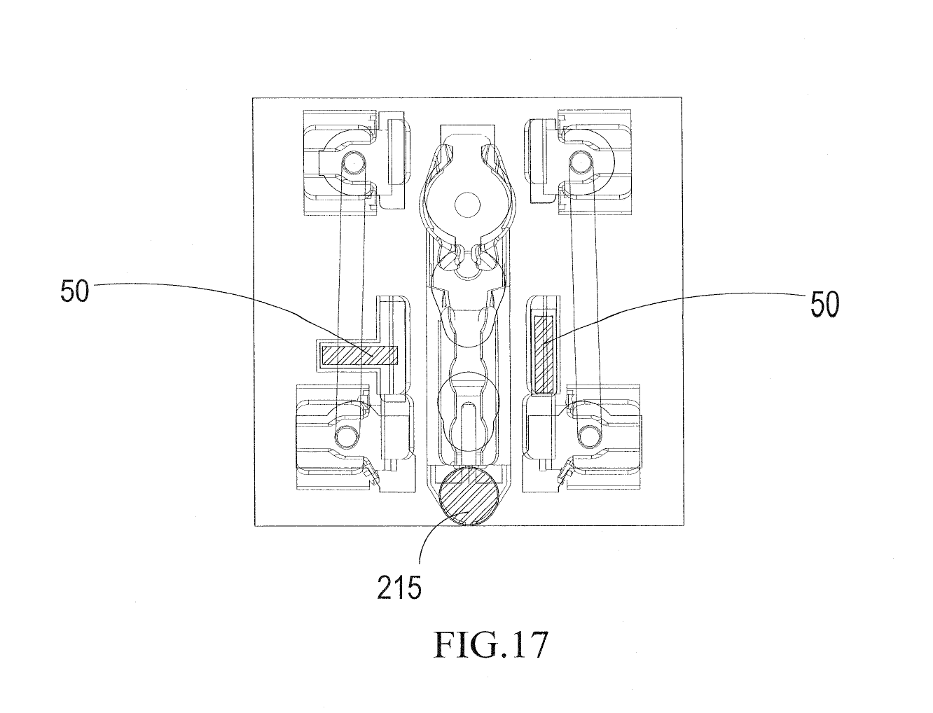

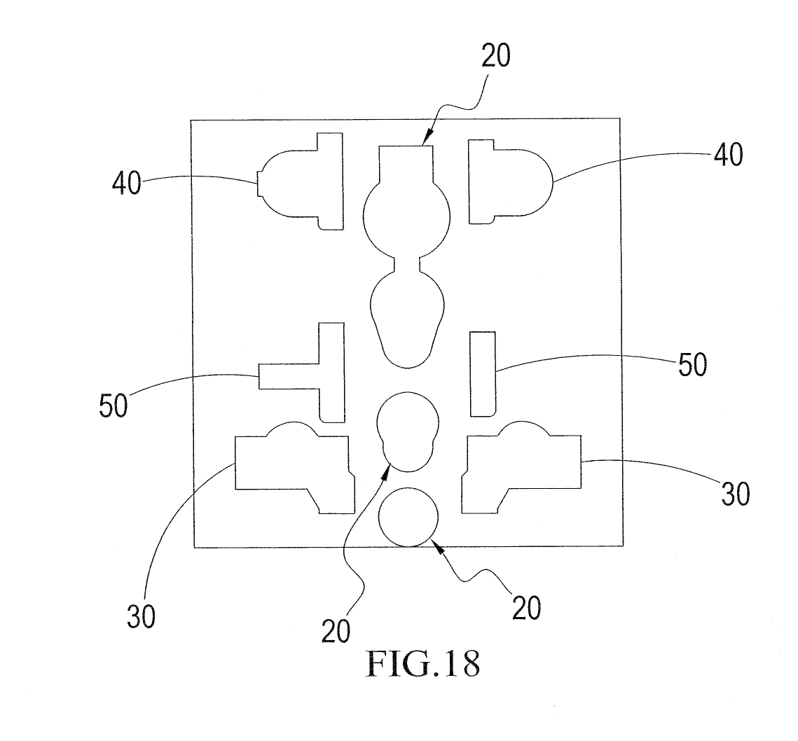

FIG. 18 shows a first embodiment of the universal plug adaptor. The various applications are described as follows. As shown in FIG. 3, when a Britain plug is plugged into the universal plug adaptor, the ground, live, and neutral pins are received by the second ground hole 202 and the plug holes of the third hole set 30, respectively. As shown in FIG. 4, when an India plug is plugged into the universal plug adaptor, the ground, live, and neutral pins are received by the third ground hole 203 and the plug holes of the third hole set 30, respectively. As shown in FIGS. 5 and 6, when a 10A and 16A China or Australia plug is plugged into the universal plug adaptor, the ground, live, and neutral pins are received by the fourth ground hole 204 and the plug holes of the third hole set 30, respectively. As shown in FIG. 7, when a Denmark plug is plugged into the universal plug adaptor, the ground, live, and neutral pins are received by the fifth ground hole 205 and the plug holes of the third hole set 30, respectively. As shown in FIG. 8, when a 10A Philippine plug of America 250V specification is plugged into the universal plug adaptor, the ground, live, and neutral pins are received by the sixth ground hole 206 and the plug holes of the third hole set 30, respectively. As shown in FIG. 9, when a 15A America plug is plugged into the universal plug adaptor, the ground, live, and neutral pins are received by the seventh ground hole 207 and the plug holes of the third hole set 30, respectively. As shown in FIG. 10, when a 20A America plug is plugged into the universal plug adaptor, the ground, live, and neutral pins are received by the eighth ground hole 208 and the plug holes of the third hole set 30, respectively. As shown in FIG. 11, when a Middle East plug is plugged into the universal plug adaptor, the ground, live, and neutral pins are received by the ninth ground hole 209 and the plug holes of the third hole set 30, respectively. As shown in FIG. 12, when an Israel plug is plugged into the universal plug adaptor, the ground, live, and neutral pins are received by the tenth ground hole 210 and the plug holes of the third hole set 30, respectively. As shown in FIG. 13, when a Brazil plug is plugged into the universal plug adaptor, the ground, live, and neutral pins are received by the eleventh ground hole 211 and the plug holes of the third hole set 30, respectively. As shown in FIG. 14, when an Italy plug is plugged into the universal plug adaptor, the ground, live, and neutral pins are received by the twelfth ground hole 212 and the plug holes of the third hole set 30, respectively. As shown in FIG. 15, when a Swiss plug is plugged into the universal plug adaptor, the ground, live, and neutral pins are received by the thirteenth ground hole 213 and the plug holes of the third hole set 30, respectively. As shown in FIGS. 16 and 17, when one of the two America 125V plug is plugged into the universal plug adaptor, the ground pins are received by the fourteenth and fifteenth ground holes 214 and 215, respectively, and the live and neutral pins are received by the plug holes of the fifth hole set 50, respectively. Additionally, depending on the requirement, the second hole set 20 can be configured with the fourth hole set 40 and the fifth hole set 50, in addition to the configuration with the third hole set 30.

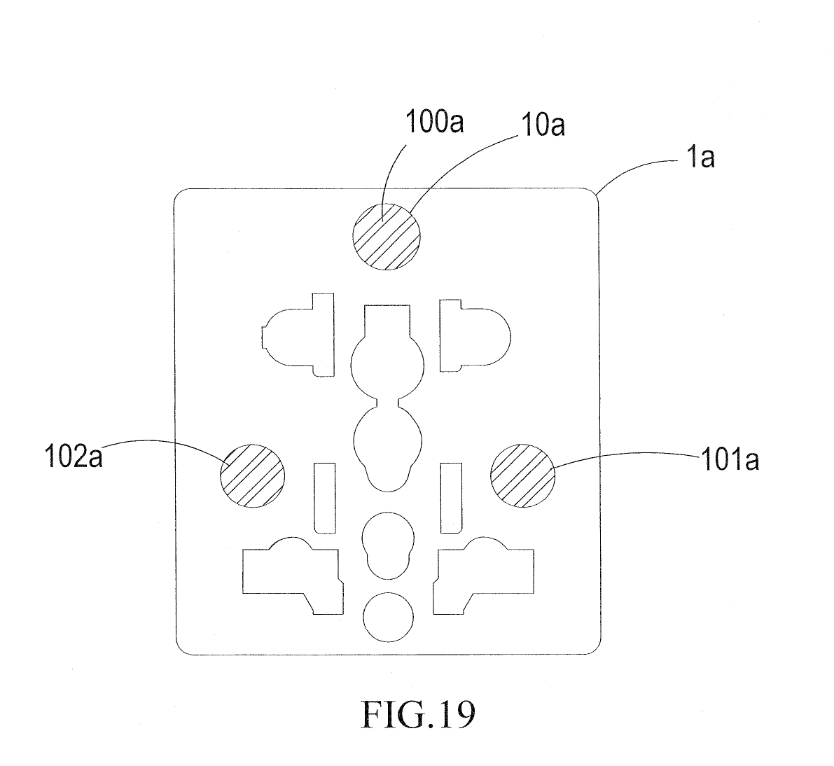

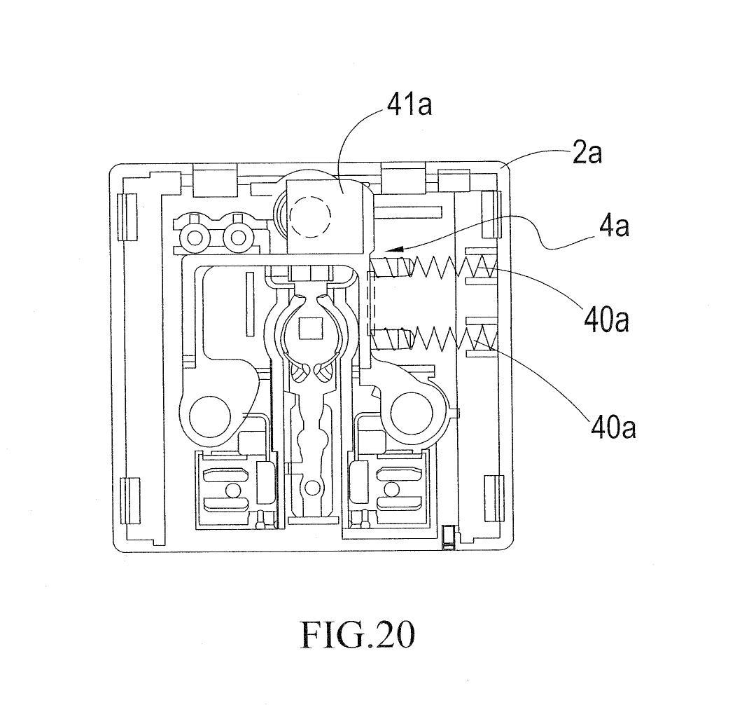

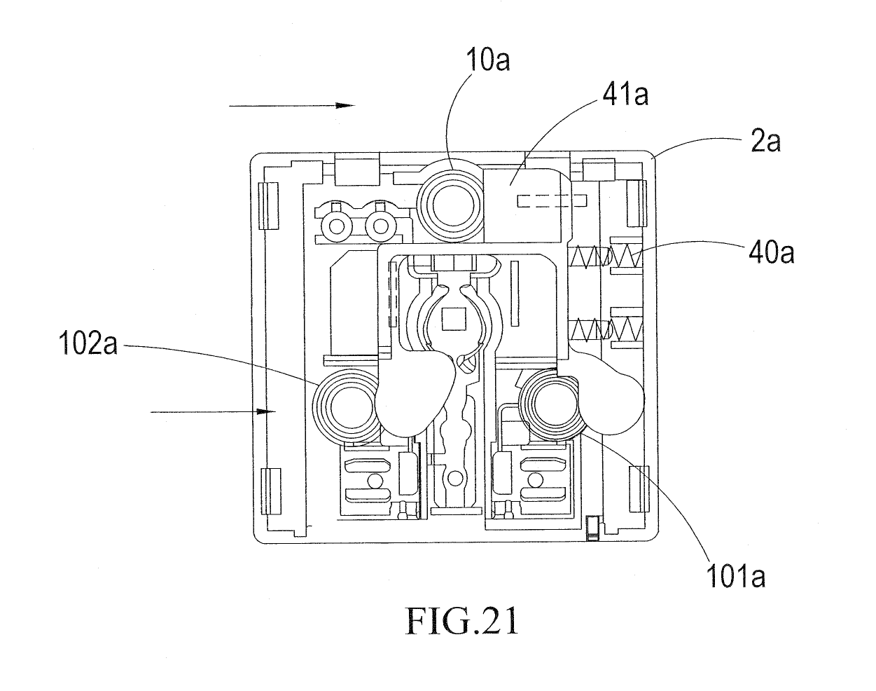

FIGS. 19 to 21 show a preferred embodiment of the universal plug adaptor for plugs conforming to the South Africa specification. As illustrated, a safety-door device 4a is configured between the face plate 1a and the casing 2a, corresponding to a first hole set 10a, a first live hole 101a, a first neutral hole 102a. The safety-door device 4a contains a number of elastic elements 40a (such as springs) and at least a guiding slope 41a for triggering the safety-door device 4a's confined movement. When a South Africa plug is plugged, the guiding slope 41a is engaged, the safety-door device 4a is moved towards a preset direction, and the elastic elements 40a are compressed. The ground, live, and neutral pins of the South Africa plug are then received by the first ground hole 100a, the first live hole 101a, and the first neutral hole 102a. When the South Africa plug is unplugged, the safety-door device 4a is restored to its original position by the expansion of the elastic elements 40a. As such, the safety-door device 4a is able to prevent miscellaneous articles from entering the universal plug adaptor and causing short circuit or other accidents.

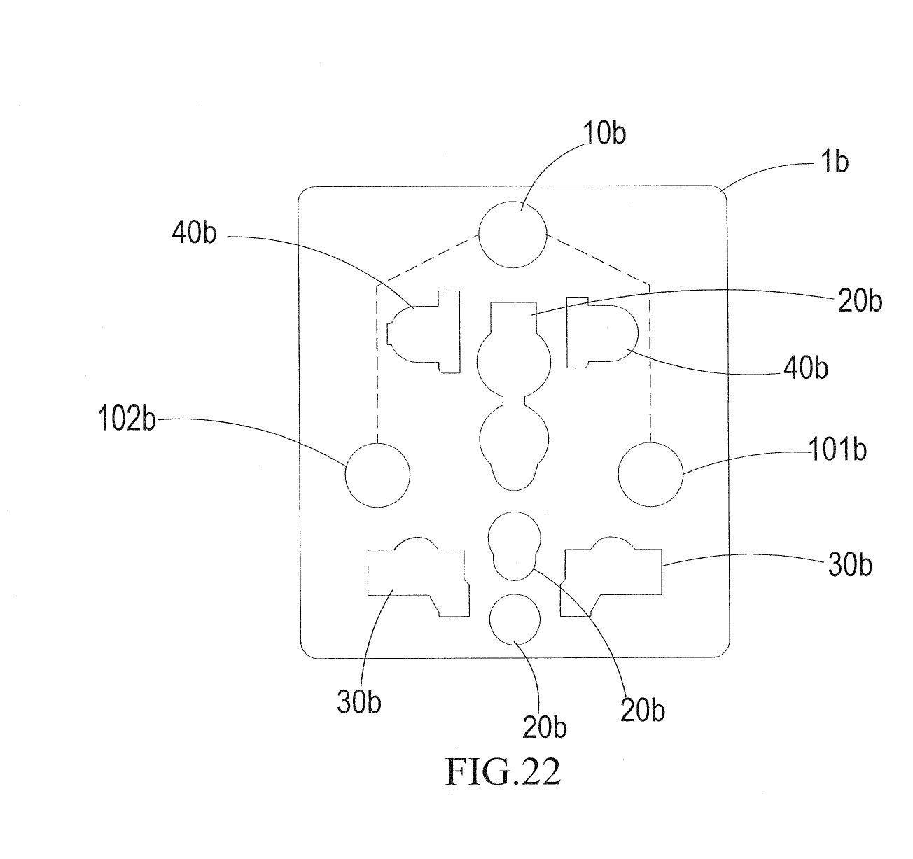

FIG. 22 shows a third embodiment of the universal plug adaptor. As illustrated, the face plate 1b contains a first hole set 10b, a second hole set 20b, a third hold set 30b, a fourth hole set 40b, and a first live hole 101b and a first neutral hole 102b corresponding to the first hole set 10b.

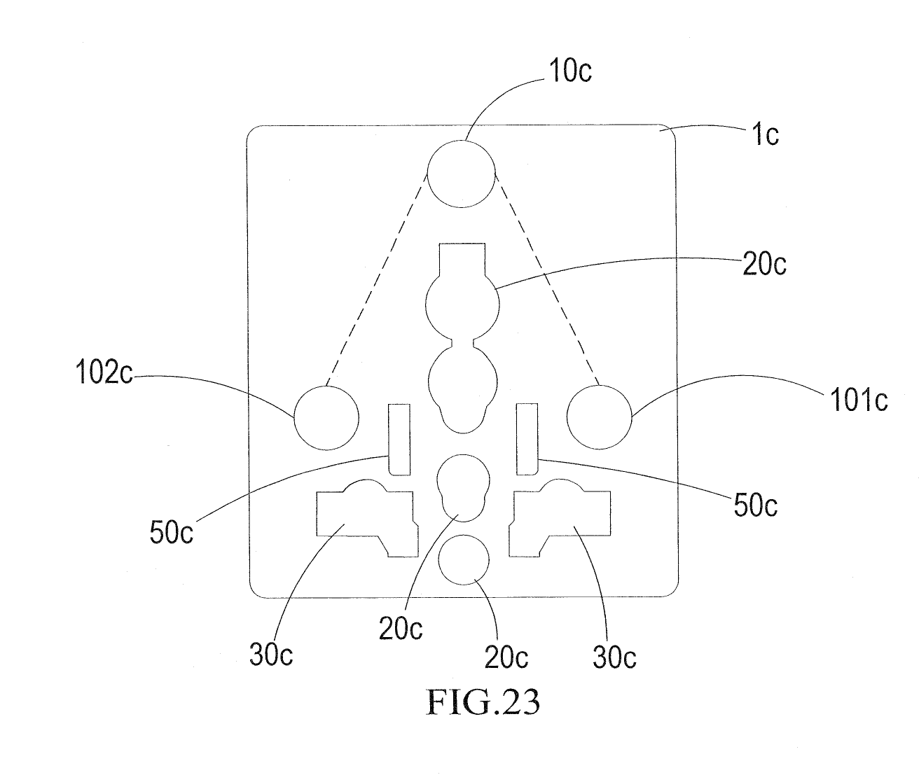

FIG. 23 shows a fourth embodiment of the universal plug adaptor. As illustrated, the face plate 1c contains a first hole set 10c, a second hole set 20c, a third hold set 30c, a fifth hole set 50c, and a first live hole 101c and a first neutral hole 102c corresponding to the first hole set 10c.

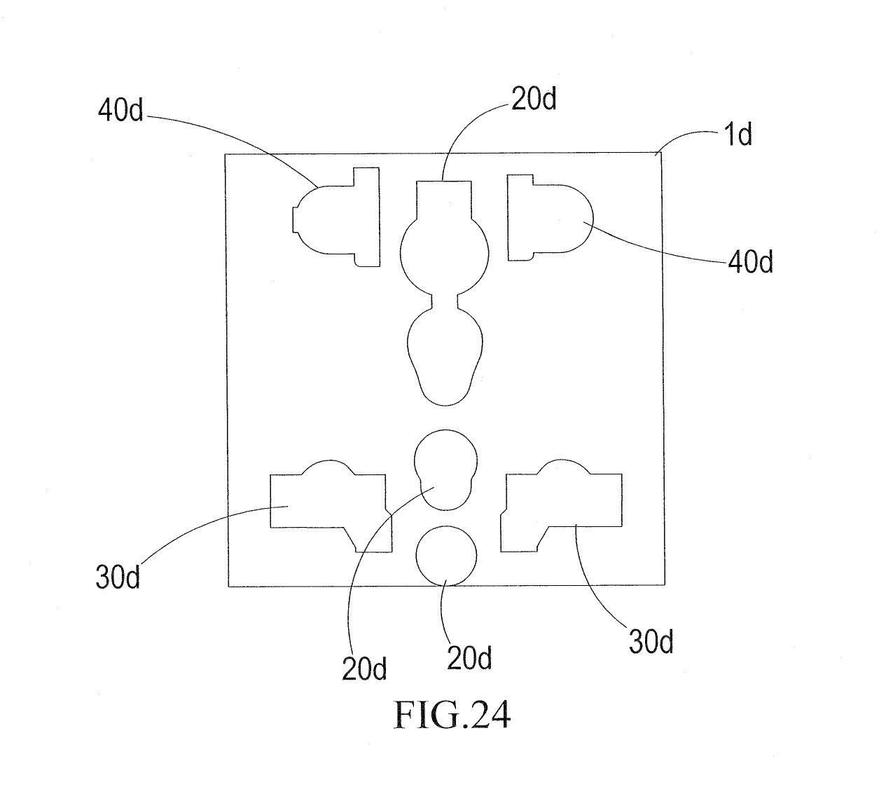

FIG. 24 shows a fifth embodiment of the universal plug adaptor. As illustrated, the face plate 1d contains a second hole set 20d, a third hold set 30d, and a fourth hole set 40d. Please note that the present embodiment allows the simultaneous plugging of two types of plugs.

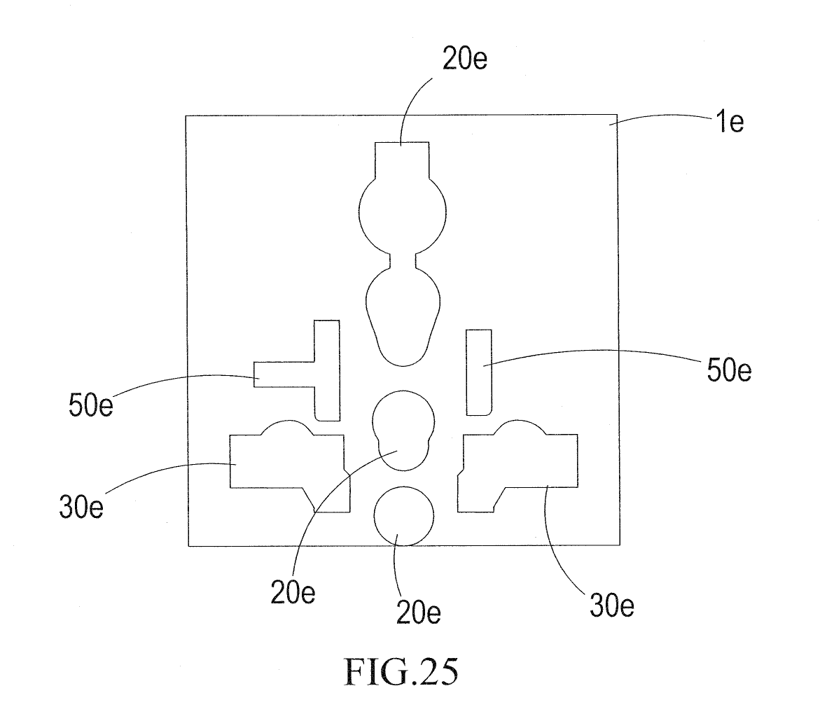

FIG. 25 shows a sixth embodiment of the universal plug adaptor. As illustrated, the face plate le contains a second hole set 20e, a third hold set 30e, and a fifth hole set 50e. Please note that one of the plug holes of the fifth hole set 50e is T-shaped.

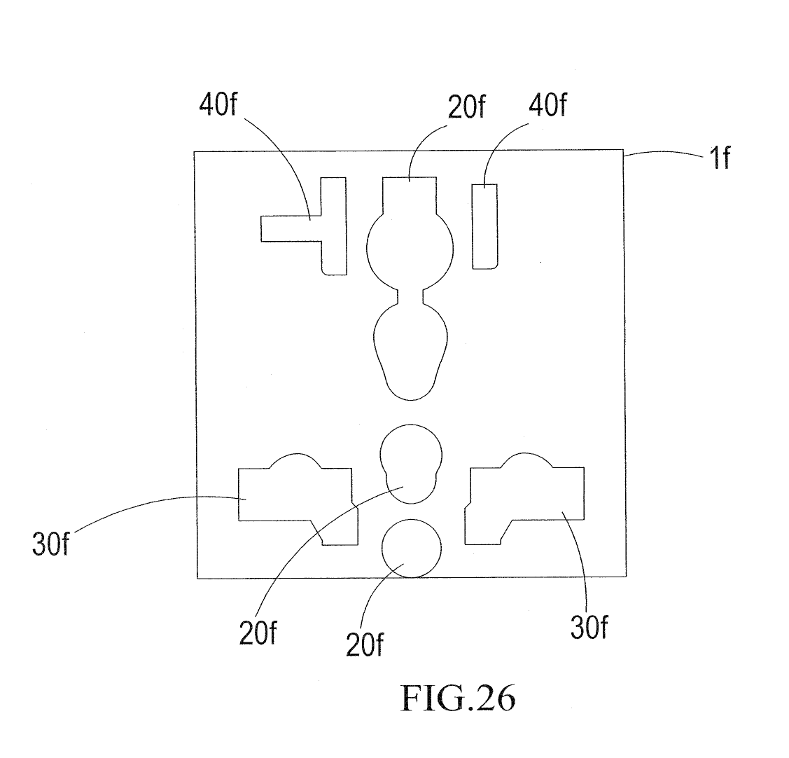

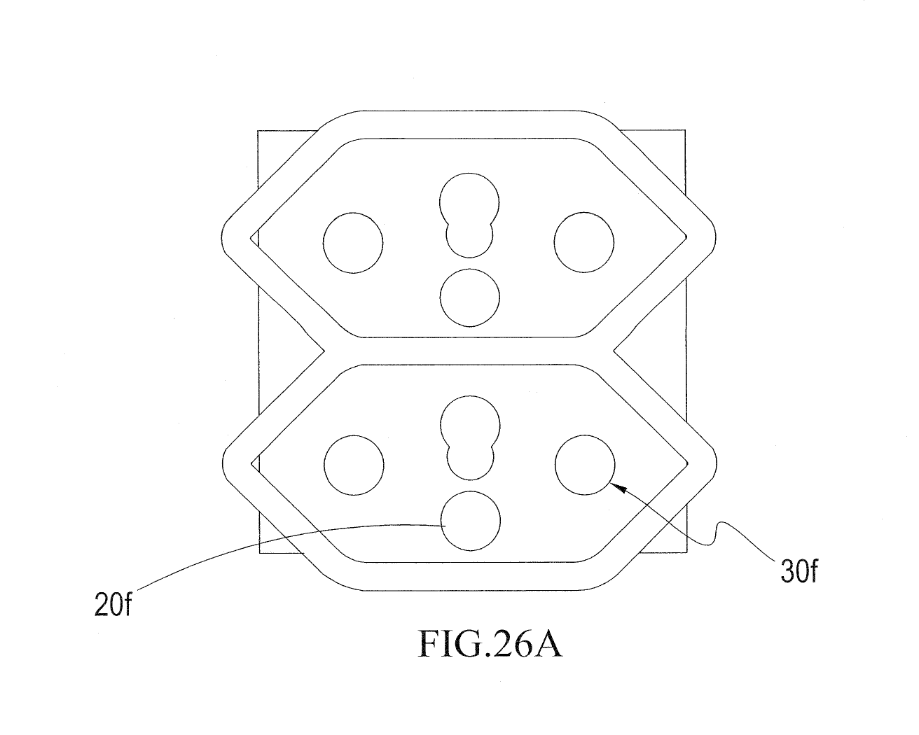

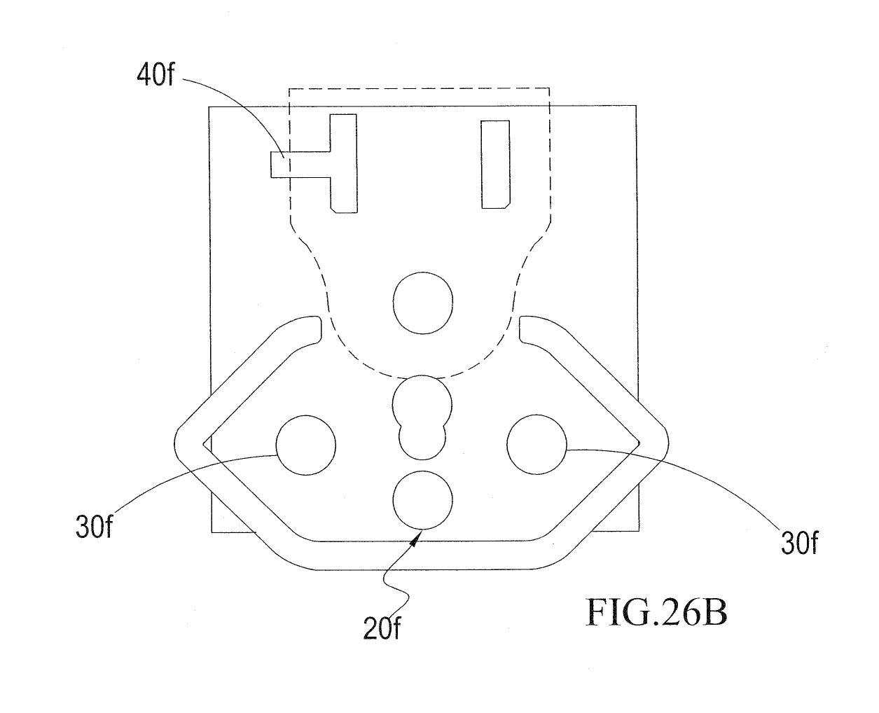

FIGS. 26, 26A, and 26B show a seventh embodiment of the universal plug adaptor. As illustrated, the face plate 1f contains a second hole set 20f, a third hold set 30f, and a fourth hole set 40f Please note that one of the plug holes of the fourth hole set 40f is T-shaped, and that the present embodiment allows the simultaneous plugging of two types of plugs. As shown in FIG. 26A, the face plate 1f contains the second hole sets 20f and the third hole sets 30f, and allows the simultaneous plugging of two Brazil plugs. As shown in FIG. 26B, the face plate 1f contains the second hole sets 20f, the third hole sets 30f, and the fourth hole sets 40f and allows the simultaneous plugging of one Brazil plug and one America plug.

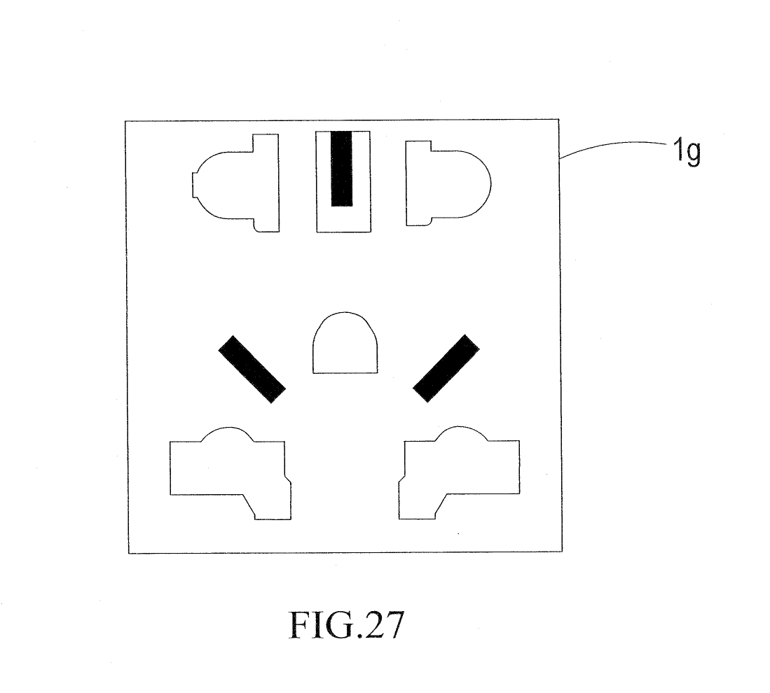

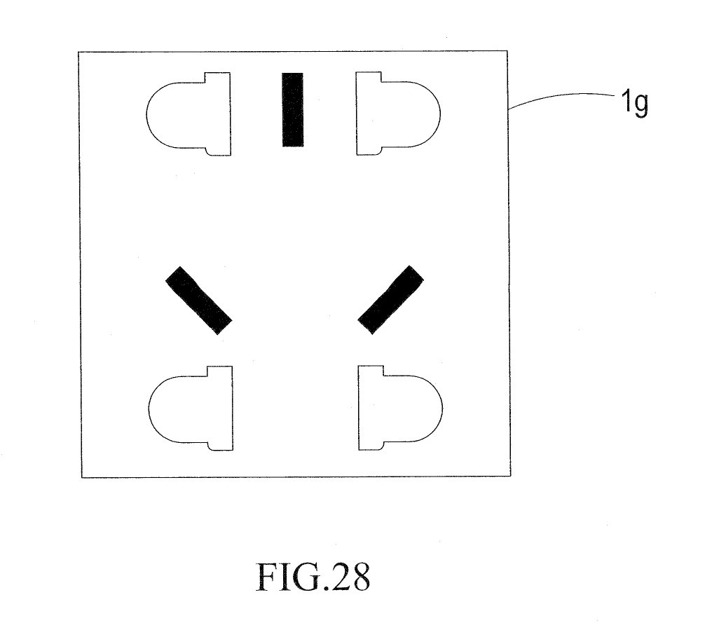

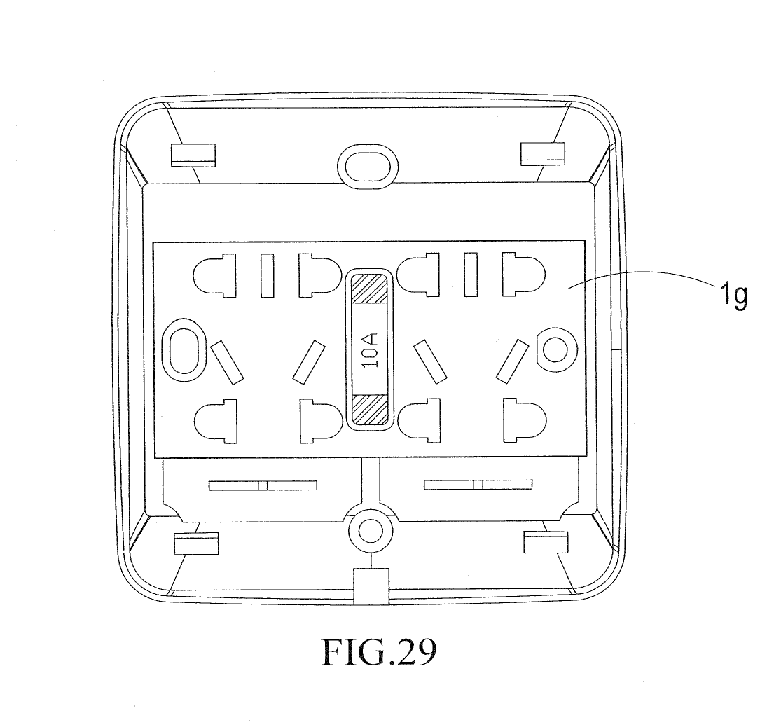

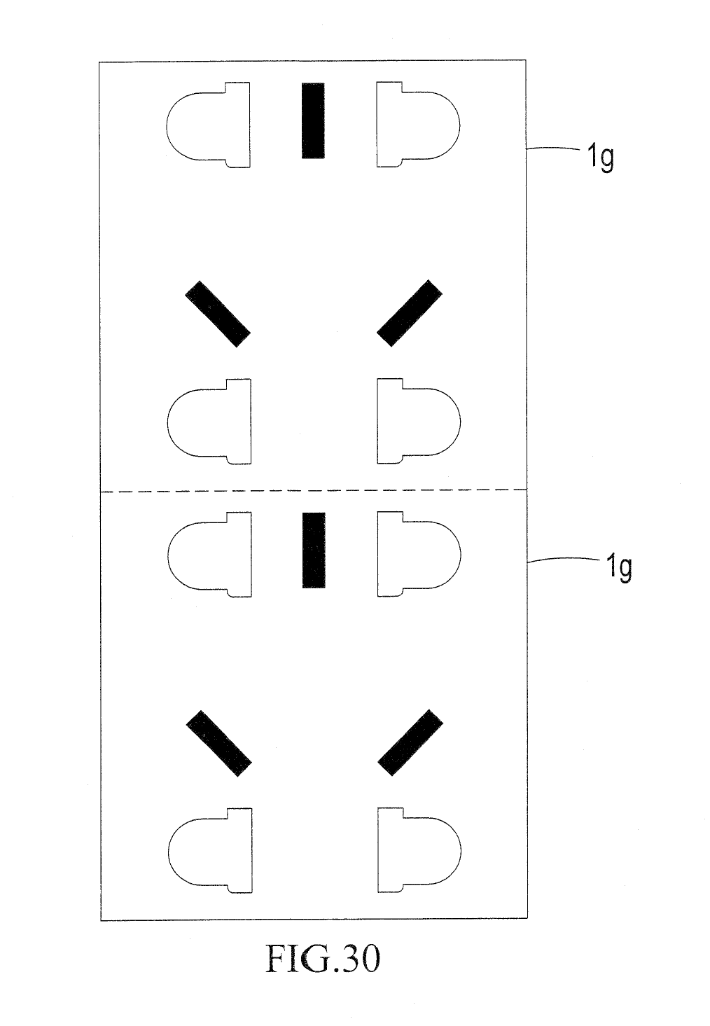

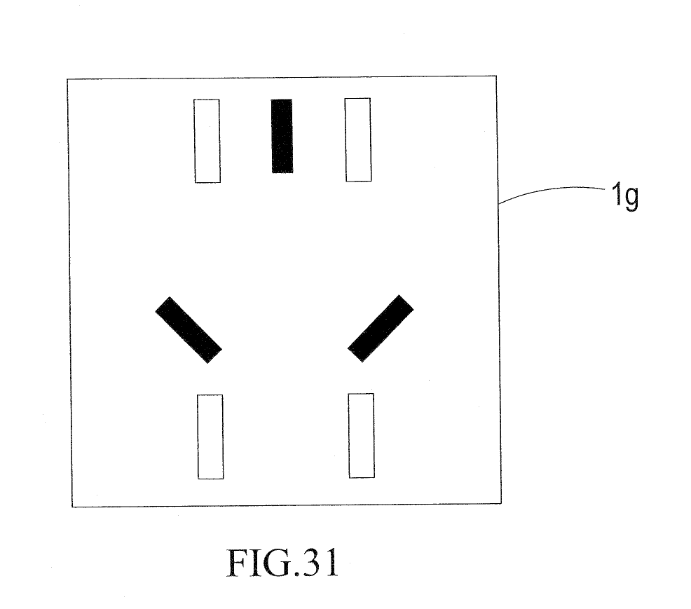

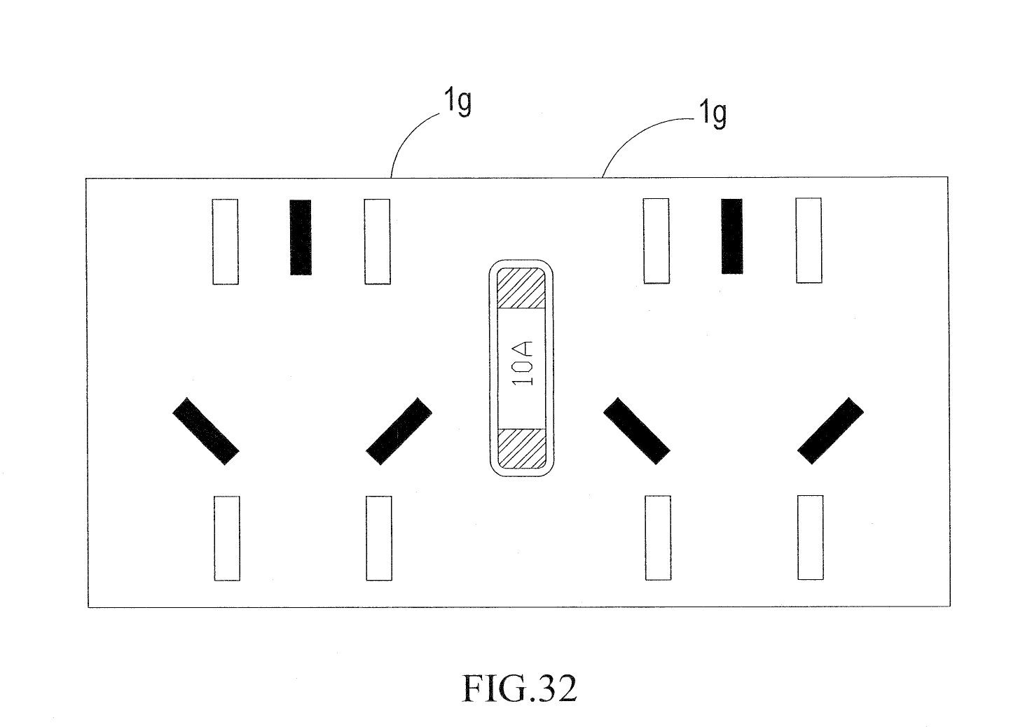

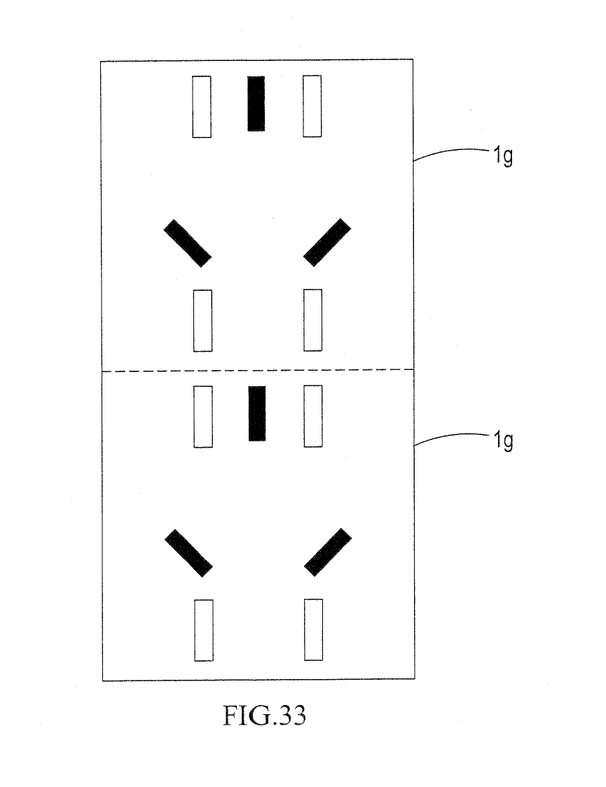

FIGS. 27 to 33 show an eighth embodiment of the universal plug adaptor. As illustrated, the face plate 1g is configured with plug holes for receiving China, Hong Kong, and Taiwan plugs, and allows the simultaneous plugging of one plug with two flat pins and one plug with two round pins. The face plate 1g could be utilized by itself (FIG. 27, FIG. 28, and FIG. 31, especially FIG. 28 where China plug and simultaneously plugging are supported), aligned laterally with another face plate 1g (FIG. 32), aligned laterally with another face plate 1g and with fuse configured (FIG. 29), or aligned vertically with another face plate 1g (FIG. 30, FIG. 33).

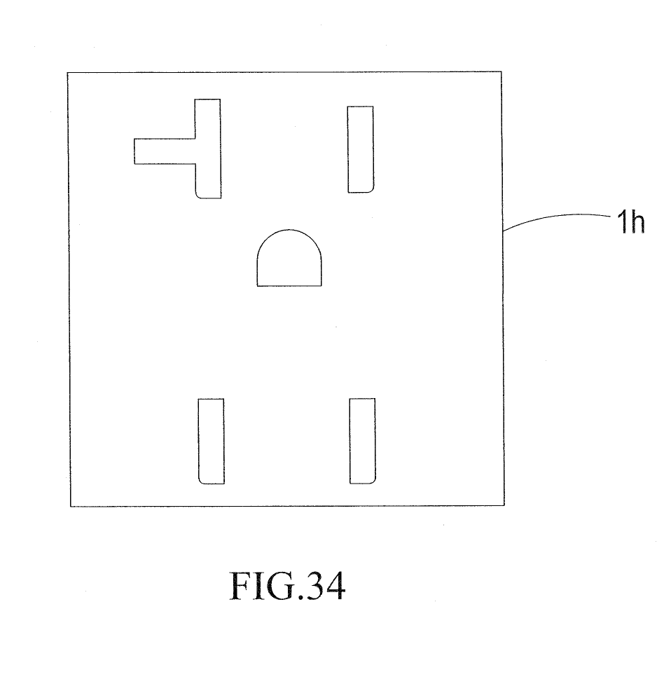

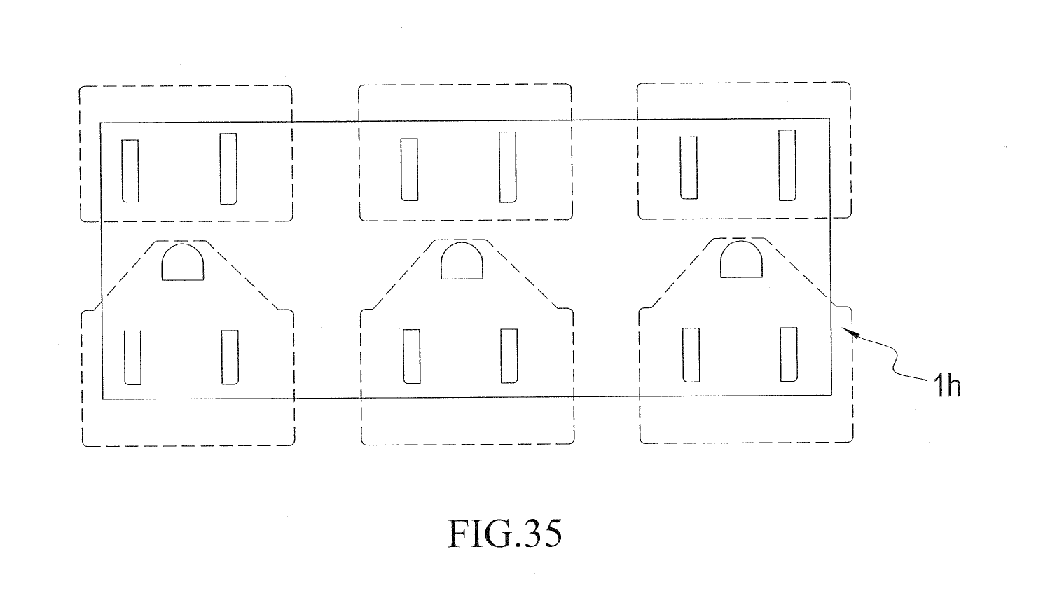

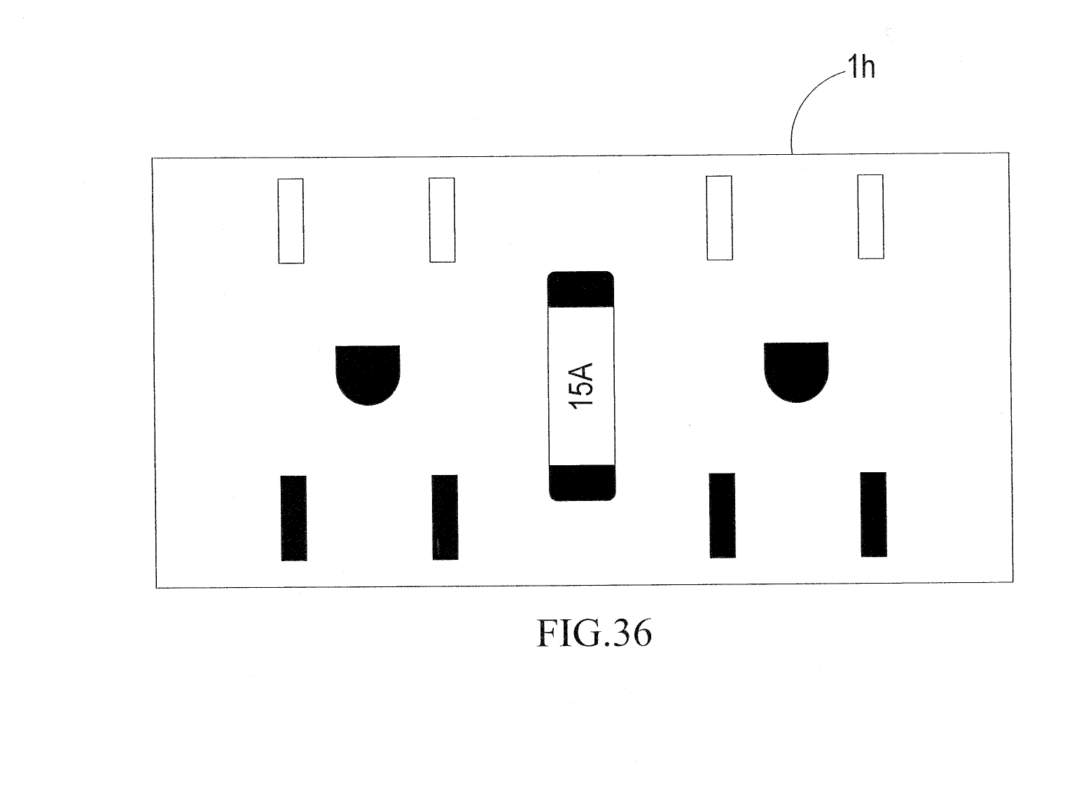

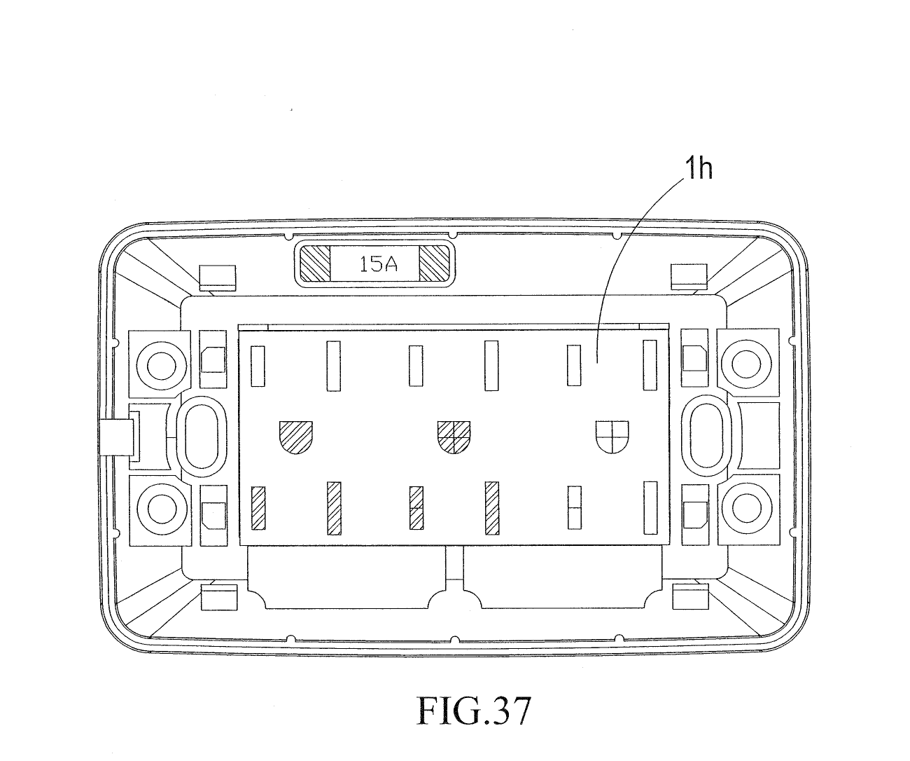

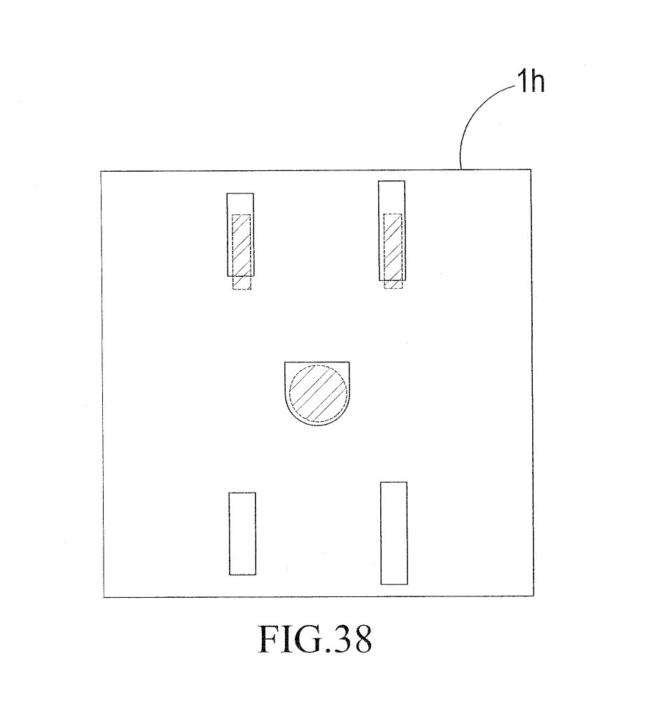

FIGS. 34 to 38 show a ninth embodiment of the universal plug adaptor. As illustrated, the face plate 1h is configured with plug holes for receiving America and Taiwan plugs, and allows the simultaneous plugging of two plugs. The face plate 1h could be utilized by itself supporting simultaneous plugging of two plugs (FIG. 34), on an extension cord (FIG. 25), aligned laterally with another face plate 1g (FIG. 32), aligned with another face plate 1h and with fuse configured (FIG. 36, FIG. 37). As shown in FIG. 38, when an America plug is reversed, it will not be received.

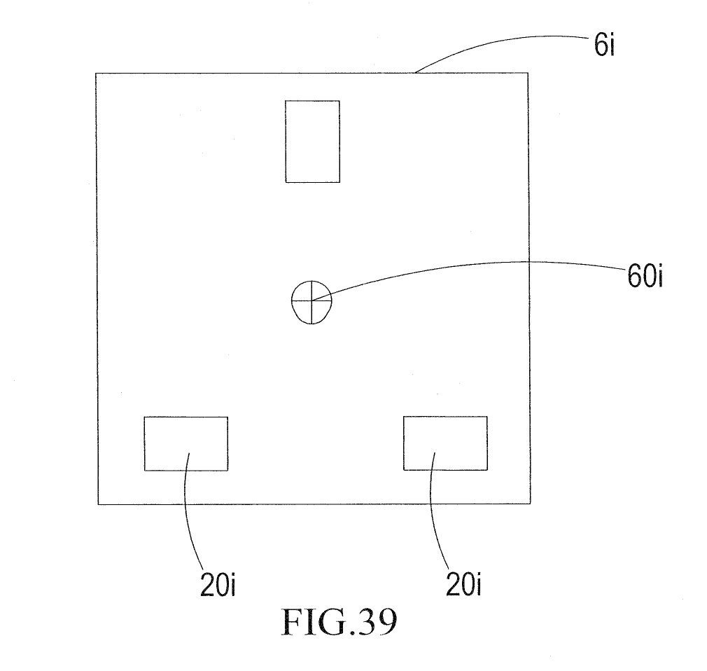

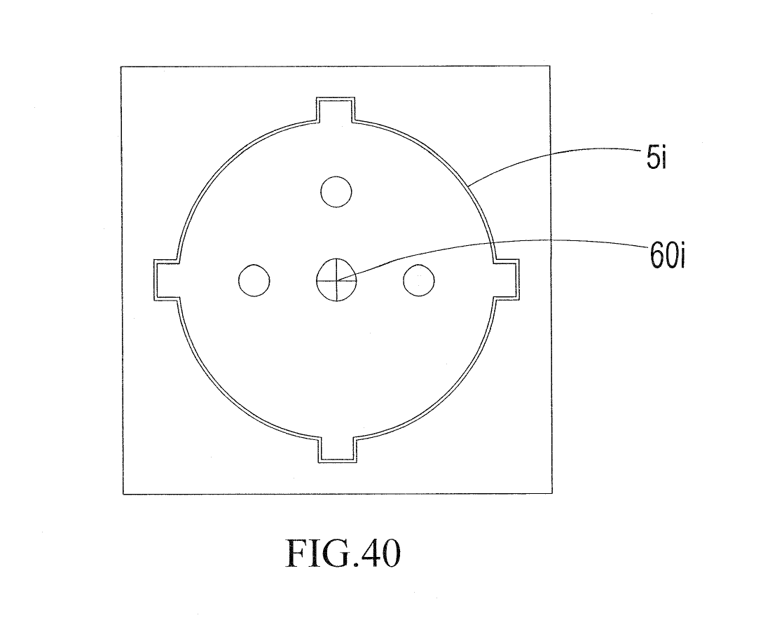

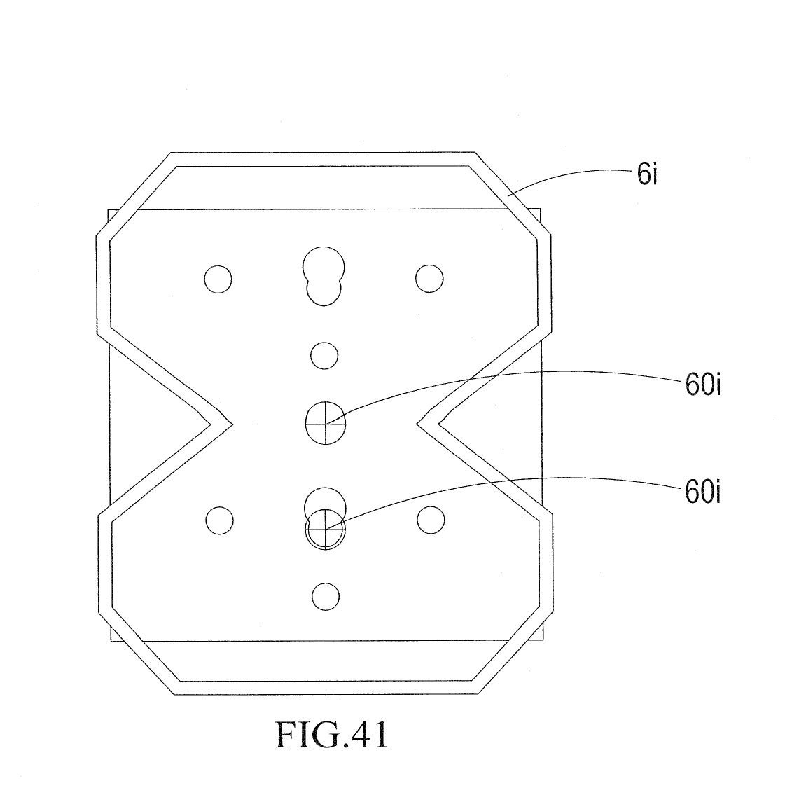

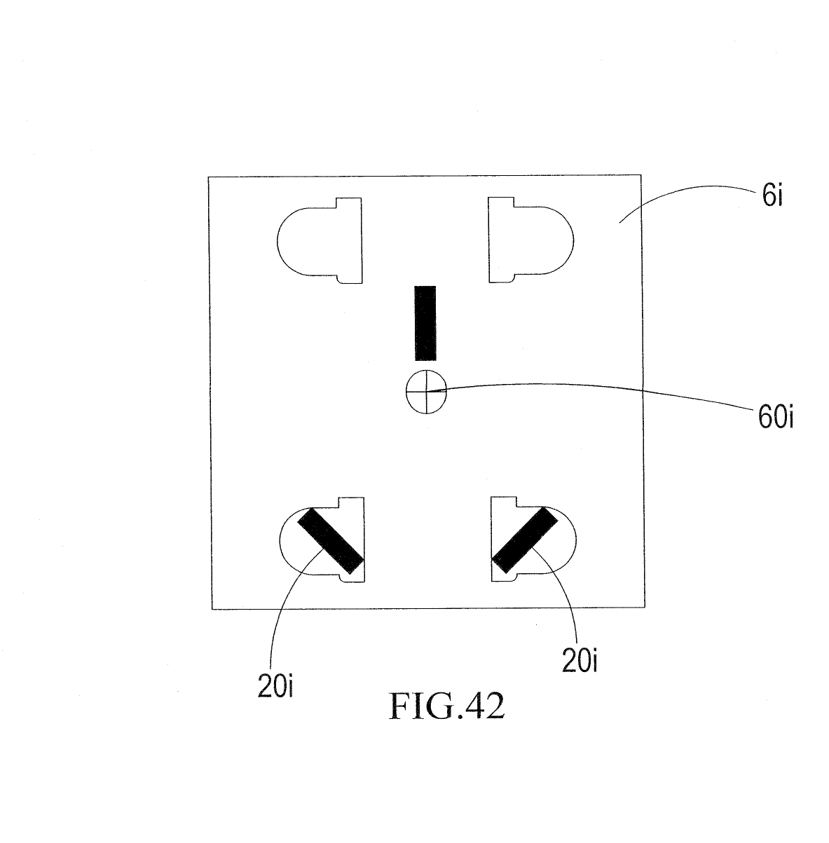

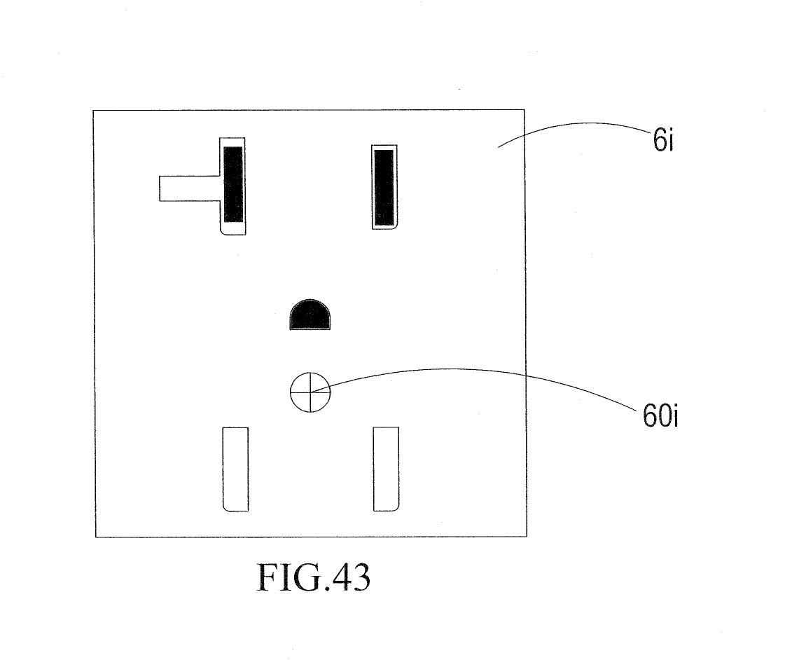

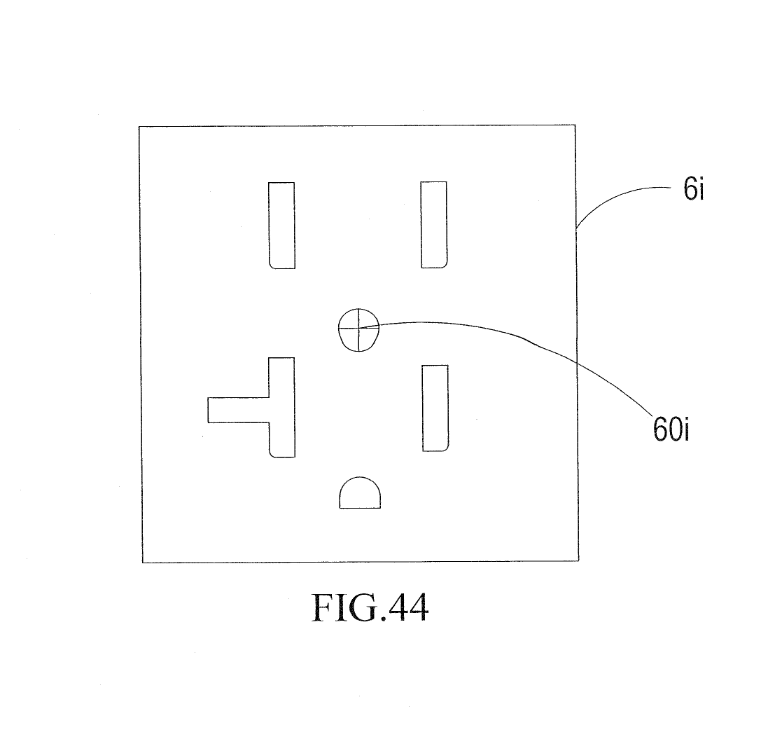

FIGS. 39 to 44 show a tenth embodiment of the universal plug adaptor. As illustrated, an additional cover plate 5i or 6i can be fastened to the face plate by at least a bolt 60i. The cover plate 6i supports Britain, Swiss, Brazil, Italy, China plugs whose live pins and neutral pins are received by the second hole set 20i or corresponding plug holes. Alternatively, the cover plate 5i conforms to Germany and French plug specifications and corresponds to the second hole set. Additionally, the rim of the cover plate 5i is configured with a ground connection element.

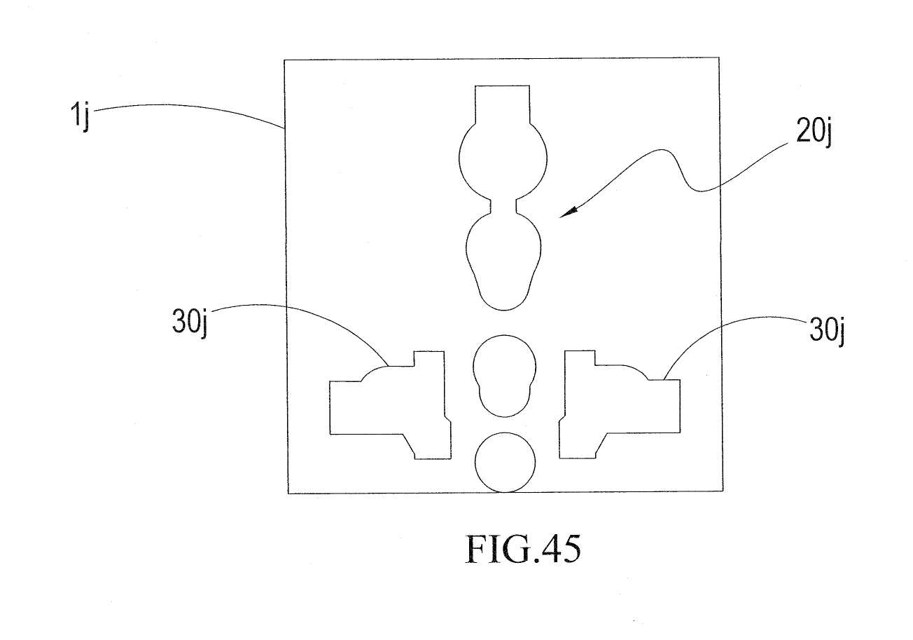

As shown in FIG. 45, the face plate 1j of an eleventh embodiment contains a second hole set 20j and a third hole set 30j.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A universal plug adaptor, comprising:
a face plate having plural sets of plug holes aligned and distributed symmetrically along a middle line of said face plate;
a casing joined to said face plate with a terminal set inside for contacting plug pins; and
a safety-door device conforming to the South Africa specification configured between said face plate and said casing 2;
wherein a first hole set of said face plate comprises a first live hole, a first neutral hole, and a first ground hole conforming to the South Africa specification;
wherein a second hole set of said face plate comprises three separate openings sequentially arranged along the middle line, each being a combination of ground holes connected sequentially together; a first opening contains a second ground hole conforming to the Britain specification, a third ground hole adjacent to said second ground hole conforming to the India specification, a fourth ground hole adjacent to said third ground hole conforming to the China and Australia 10A and 16A specifications, a fifth ground hole adjacent to said fourth ground hole conforming to the Denmark specifications, a sixth ground hole adjacent to said fifth ground hole conforming to the Philippine 10A specification of America 250V, a seventh ground hole coinciding with said sixth ground hole conforming to the America 15A specification, an eighth ground hole coinciding with said sixth and seventh ground holes conforming to the America 20A specification, a ninth ground hole adjacent to said sixth, seventh, and eighth ground holes and conforming to the Middle East specification, and a tenth ground hole adjacent to said ninth ground hole and conforming to the Israel specification; a second opening contains an eleventh ground hole conforming to the Brazil specification and a twelfth ground hole adjacent to said eleventh ground hole and conforming to the Italy specification; and a third opening contains a thirteenth ground hole conforming to Swiss specification, and a fourteenth ground hole and a fifth ground hole, conforming to two types of America 125V specifications;
wherein a third hole set of said face plate comprises two symmetric plug holes conforming to global 250V specification with two flat pins or two round pins;
wherein a fourth hole set comprises two symmetric plug holes conforming to America 125V specification with two flat pints or two round pins;
wherein a fifth hole set comprises two plug holes conforming to America specification with two flat pins;
wherein said third and fourth hole sets jointly provide two plugs' simultaneous plugging.

2. The universal plug adaptor according to claim 1, wherein said terminal set is capable of receiving, through said second, third, fourth, and fifth hole sets, plugs conforming to Brazil, Italy, Swiss, two type of America 125V plugs with two flat pins, America 125V specification with two flat pints or two round pins.

3. The universal plug adaptor according to claim 1, wherein said face plate is fastened with at least a cover plate having a plurality of plug holes.

4. The universal plug adaptor according to claim 1, wherein said first hole set, said third hole set, and said fourth hole set, together with said second hole set, are capable of receiving plugs conforming to the South Africa, Britain, India, China and Australia 10A and 16A, Denmark, Philippine of America 250V, America 15A and 20A, Middle East, Israel, Brazil, Italy, Swiss, two type of America 125V with two flat pins, America 125V with two flat pints or two round pins specifications; and allow for the simultaneous plugging of two plugs.

5. The universal plug adaptor according to claim 1, wherein said first hole set, said third hole set, and said fifth hole set, together with said second hole set, are capable of receiving plugs conforming to the South Africa, Britain, India, China and Australia 10A and 16A, Denmark, Philippine of America 250V, America 15A and 20A, Middle East, Israel, Brazil, Italy, Swiss, two type of America 125V with two flat pins, America 125V with two flat pints or two round pins specifications.

6. The universal plug adaptor according to claim 1, wherein said third hole set, and said fourth or fifth hole set, together with said second hole set, are capable of receiving plugs conforming to the Britain, India, China and Australia 10A and 16A, Denmark, Philippine of America 250V, America 15A and 20A, Middle East, Israel, Brazil, Italy, Swiss, two type of America 125V with two flat pins, America 125V with two flat pints or two round pins specifications; and allow for the simultaneous plugging of two plugs.

7. The universal plug adaptor according to claim 1, wherein said third hole set, together with said second hole set, are capable of receiving plugs conforming to Britain, India, China and Australia 10A and 16A, Denmark, Philippine of America 250V, America 15A and 20A, Middle East, Israel, Brazil, Italy, Swiss, and two type of America 125V with two flat pins.

8. The universal plug adaptor according to claim 1, further comprising a second face plate; and said second face plate comprises a combination of said first, second, third, fourth, and fifth hole sets.

9. The universal plug adaptor according to claim 1, wherein said universal plug adaptor conforms to ground pins of various specifications and allows for the simultaneous plugging of two plugs.

10. The universal plug adaptor according to claim 1, wherein said face plate is fastened with at least a cover plate having a plurality of plug holes conforming to Germany and French plug specifications; the rim of said cover plate is configured with a ground connection element; and said cover plate corresponds to said second hole set.
